(19) United States
(12) Patent Application Publication
(10) Pub. No.: US 2024/0262642 A1
(43) Pub. Date: Aug. 8, 2024

(54) RAILCAR RAMP SYSTEMS AND RELATED METHODS

(71) Applicant: RITE-HITE HOLDING CORPORATION, Milwaukee, WI (US)

(72) Inventors: Nicholas A. Beyer, New Berlin, WI (US); Greg D. Proffitt, Waukesha, WI (US); Roger John Quint, Waukesha, WI (US); Robert L Jung, Menomonee Falls, WI (US)

(21) Appl. No.: 18/431,358

(22) Filed: Feb. 2, 2024

Related U.S. Application Data
(60) Provisional application No. 63/483,214, filed on Feb. 3, 2023.

(51) Int. Cl. B65G 69/28

(52) U.S. Cl. CPC B65G 69/2847; B65G 69/287

(57) ABSTRACT

Railcar ramp systems and related methods are disclosed. An example railcar ramp system includes a carriage slidably coupled to a platform via a track guide. A ramp mover assembly is pivotally coupled to the carriage. The ramp mover assembly positionable between a stored position and an active position. In the active position, the ramp mover to enable movement of the carriage in a lateral direction along the track guide.

### CROSS-REFERENCE TO RELATED APPLICATION

This patent claims the benefit of U.S. Provisional Patent Application No. 63/483,214, filed Feb. 3, 2023, which is incorporated by reference herein in its entirety. Priority to U.S. Provisional Patent Application No. 63/483,214 is hereby claimed.

### FIELD OF THE DISCLOSURE

This disclosure relates generally to dock levelers and, more particularly, to railcar ramp systems and related methods.

### BACKGROUND

Railway freight cars (e.g., boxcars) can be used to transport cargo. The cargo is generally loaded and/or unloaded through sliding doors disposed within the longitudinal side of the boxcar when the boxcar is parked parallel to the edge of a cargo terminal (e.g., a warehouse, a railyard structure, etc.).

### BRIEF DESCRIPTION OF THE DRAWINGS

FIG. 1 is a perspective view of an example loading bay implemented with an example railcar ramp system in accordance with teachings disclosed herein.

FIG. 2 is a side view of the example loading bay of FIG. 1 showing an example railcar parked at the example loading bay and the example railcar ramp system in an example first operational or endload position.

FIG. 3 is a side view of the example loading bay of FIG. 1 showing the example railcar parked at the example loading bay and the example railcar ramp system in an example second operational or deployed position.

FIG. 4 is a perspective view of the example railcar ramp system of FIGS. 1-3.

FIG. 5A is a perspective, rear view of the example railcar ramp system of FIGS. 1-4.

FIG. 5B is a side, rear view of FIG. 5A

FIG. 5C is a partial, enlarged view of FIG. 5A.

FIG. 6 is a cross-sectional side view of an example track system 400 of the example railcar ramp system of FIGS. 1-4, and 5A-5C.

FIG. 7 is a partial perspective view of the example railcar ramp system of FIGS. 1-6.

FIG. 8 is a perspective, rear view of an example ramp mover of the example railcar ramp system of FIGS. 1-7.

FIG. 9 is a perspective view of the example railcar ramp system of FIGS. 1-8.

FIG. 10A is a front view of the example railcar ramp system of FIGS. 1-8.

FIG. 10B is a side view of the example railcar ramp system of FIG. 10A.

FIG. 10C is an enlarged portion of the example railcar ramp system of FIG. 10B.

FIG. 11 is a perspective view of the example railcar ramp system of FIGS. 1-9.

FIG. 12A is an enlarged, front view of an example control panel of the example railcar ramp system of FIGS. 1-11.

FIG. 12B is another enlarged, front view of the example control panel of FIG. 12A.

FIG. 12C is an enlarged, rear view of the example control panel of FIG. 11.

FIG. 13 is a cross-sectional view of the example control panel taken along 13-13 of FIG. 10A.

FIG. 14A is a side view of the example control panel shown in an example deflected position.

FIG. 14B is a partial, enlarged view of FIG. 14B.

FIG. 15A is an enlarged perspective, rear view of the example control panel of FIG. 14A in the example deflected position.

FIG. 15B is an enlarged perspective, front view of the example control panel 136 of FIG. 14A in the deflected position.

FIGS. 16A-16E are different views of the example control panel disclosed herein coupled to fixed platform of an example loading dock.

FIG. 17A is a perspective view of another example loading dock including another example control panel disclosed herein.

FIG. 17B is another perspective view of the example control panel of FIG. 17A.

FIG. 18 is a perspective, rear view of the example control panel of FIGS. 17A and 17B.

FIG. 19 is a front view of the example control panel of FIGS. 17A, 17B and 18 in an example first position.

FIG. 20 is a front view of the example control panel of FIGS. 17A, 17B and 18 in an example second position.

FIG. 21A is a perspective view of another example control panel disclosed herein.

FIG. 21B is another perspective view of the example control panel of FIG. 21A.

FIG. 21C is a perspective, rear view of the example control panel of FIGS. 21A and 21B.

FIG. 21D is a side view of the example control panel of FIGS. 21A and 21B.

In general, the same reference numbers will be used throughout the drawing(s) and accompanying written description to refer to the same or like parts. The figures are not to scale. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

### DETAILED DESCRIPTION

Railyards and/or warehouses employ cargo terminals or loading docks for loading and/or unloading goods between the loading docks and railcars. The loading dock typically includes a platform, and the railcar is positioned substantially parallel relative to the platform to enable loading/unloading of cargo or goods between a cargo area or bed of the railcar and the platform via a side door of the railcar oriented toward the platform. To span a gap between and/or to compensate for height difference between a platform of a loading lock and a cargo bed of a railcar (e.g., a boxcar), the loading dock typically employs a railcar ramp (e.g., a hydraulic railway ramp). In addition, it can be difficult to properly align a railcar with the railcar ramp. Thus, in addition to compensating for height difference between the platform and the cargo bed, railcar ramps are often slidably coupled to the platform to enable lateral adjustment and/or alignment of the railcar ramp relative to a side door of a railcar. After the railcar ramp is positioned relative to the side door of the railcar, a loading/unloading operation can be achieved by a material handling vehicle, such as a conventional forklift truck, that can access the cargo through the side door of the railcar.

To move the railcar ramp laterally along a longitudinal axis of the railcar, the railcar ramp often employs a motorized or hydraulic mover system. Specifically, the motorized system often includes a motor coupled to a transmission system that moves the railcar ramp along a track. Such motorized transmission systems can include a rack-and-pinon, a gear transmission, a chain, and sprocket transmission, and/or any other transmission that can be operated by a motor. A hydraulic system can include a hydraulic cylinder converted to the carriage and a fixed mount bolted directly to the dock face. Such motorized systems are often expensive and prone to wear, which increases maintenance costs and/or increases downtime of a cargo terminal or loading dock.

Example methods, apparatus, and articles of manufacture disclosed herein provide a mover assembly for moving a railcar ramp laterally relative to a railcar. Specifically, example apparatus methods, apparatus, and articles of manufacture disclosed herein enable lateral movement of the railcar ramp without use of a convention transmission system (e.g., a gear train or other motorized transmission). To the contrary, example lateral mover systems disclosed herein employ a frame (e.g., a pusher frame) that enables movement of the railcar ramp along a longitudinal axis of the railcar. The lateral mover can be moved manually and/or can be moved via a fork truck or other vehicle employed to unload/load the cargo of the railcar.

Additionally, methods, apparatus, and articles of manufacture disclosed herein employ an impactable control panel. Specifically, railcar ramps often employ motorized and/or hydraulic systems to move the railcar ramp (e.g., vertically) relative to the cargo area of the railcar. Such a control panel is often positioned adjacent relative to the railcar ramp. As such, control panels of railcar ramp systems are susceptible to damage when impacted by material handling equipment during a loading/unloading operation. Example control panels disclosed herein employ a spring-loaded hinge connection that enables the control panel to pivot relative to the platform and/or the railcar ramp. For example, control panel structures disclosed herein can pivot relative to the platform and/or the railcar ramp in a direction away from the platform and toward the railcar. Example spring assembly enables the control panel to return to an initial position (e.g., a non-impacted position) when the material handling equipment releases the control panel.

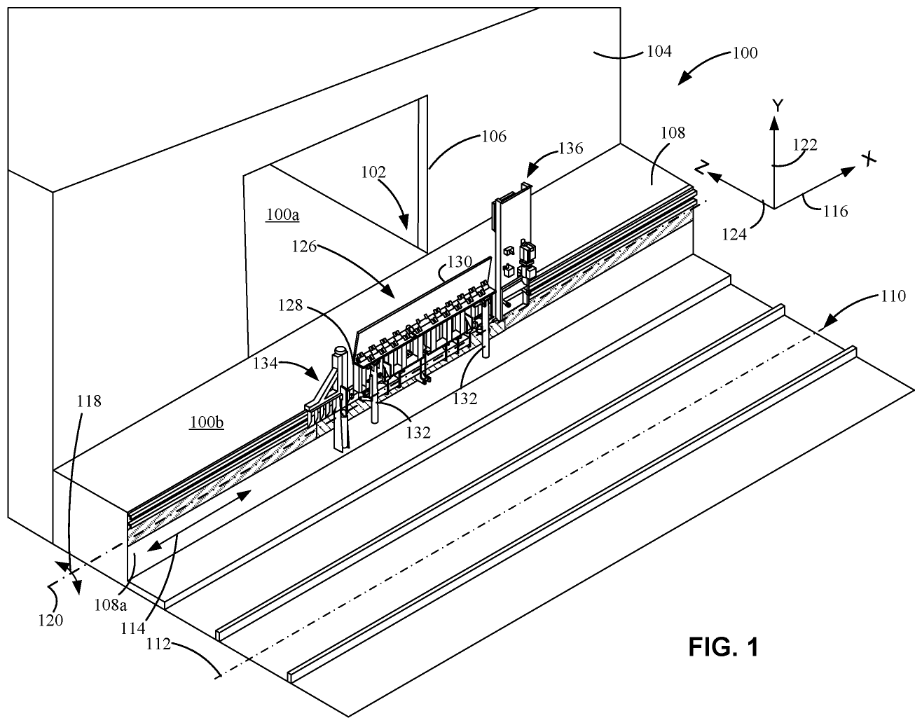

FIG. 1 is a perspective view of an example loading bay 100 implemented with an example railcar ramp system 102 in accordance with teachings disclosed herein. The loading bay 100 of the illustrated example can be a warehouse, a railyard, cargo transport unit, and/or loading structure. The loading bay 100 of the illustrated example includes a building wall 104 defining a doorway 106 leading to a platform 108 (e.g., the doorway 106 allows access between an interior 100a of the loading bay 100 and an exterior 100b of the loading bay 100). The loading bay 100 of the illustrated example includes a rail 110 for receiving one or more railcars (e.g., boxcars) of a freight train. The rail 110 defines a longitudinal axis 112. In the illustrated example, the rail 110 and/or the longitudinal axis 112 extends substantially parallel relative to the building wall 104.

The railcar ramp system 102 of the illustrated example is coupled to a platform face or front face 108a (e.g., a dock face, a front face, a vertical wall, a platform face, etc.) of the platform 108. The railcar ramp system 102 of the illustrated example enables alignment of the railcar ramp system 102 and a railcar when a railcar is not in alignment (e.g., perfect alignment) with the doorway 106 and/or the railcar ramp system 102. For example, the railcar ramp system 102 of the illustrated example is to span a gap and/or compensate for height difference between the platform 108 of the loading bay 100 and a cargo bed of a railcar (e.g., a boxcar. In addition to compensating for a height difference between the platform 108 and the cargo bed, the railcar ramp system 102 moves (e.g., slides) in a first direction 114 (e.g., a bi-directional lateral or horizontal direction, first and second lateral directions) relative to the platform 108 to enable lateral adjustment and/or alignment of the railcar ramp system 102 relative to a railcar (e.g., relative to a side door of a railcar). In the illustrated example, the first direction 114 is bi-directional along the longitudinal axis 112. As used herein, the first direction 114 of the railcar ramp system 102 is in a direction substantially parallel or perfectly parallel along the longitudinal axis 112 (e.g., an x-axis 116 in the illustrated example of FIG. 1). As such, to laterally align a railcar door and the railcar ramp system 102 and/or to span the gap (e.g., a vertical gap) between a railcar cargo area and the platform 108 of the loading bay 100, the railcar ramp system 102 is movable in the first direction 114 (e.g., a lateral or horizontal direction) and a second direction 118 (e.g., a vertical or rotational direction) about a pivot axis 120. Thus, the first direction 114 is different than the second direction 118. In some examples, the railcar ramp apparatus moves in the first direction 114 along a plane defined by the x-axis 116 and a y-axis 122 in the orientation of FIG. 1, and the second direction 118 along a plane defined the y-axis 122 and a z-axis 124 in the orientation of FIG. 1.

To span a gap between a rail car and the platform 108, the railcar ramp system 102 of the illustrated example includes a ramp or leveler 126 (e.g., a ramp assembly or system). The leveler 126 of the illustrated example includes a deck 128, a lip 130 and end loading legs 132. To laterally align the railcar ramp system 102 relative to the platform 108, the railcar ramp system 102 of the illustrated example includes a ramp mover 134. The ramp mover 134 of the illustrated example is configurable to selectively move the ramp assembly in the first direction 114 (e.g., laterally) along the platform 108. Additionally, to support one or more electronic components (e.g., motors, controllers, hydraulic reservoirs, etc.) of the railcar ramp system 102, the railcar ramp system 102 of the illustrated example includes a control panel 136.

While one loading bay 100 is illustrated in FIG. 1, the loading bay 100 can include a plurality of loading bays positioned adjacent to the loading bay 100. In some such examples, each of the loading bays can include a dedicated railcar ramp system. Alternatively, two or more bays can share a single railcar ramp system.

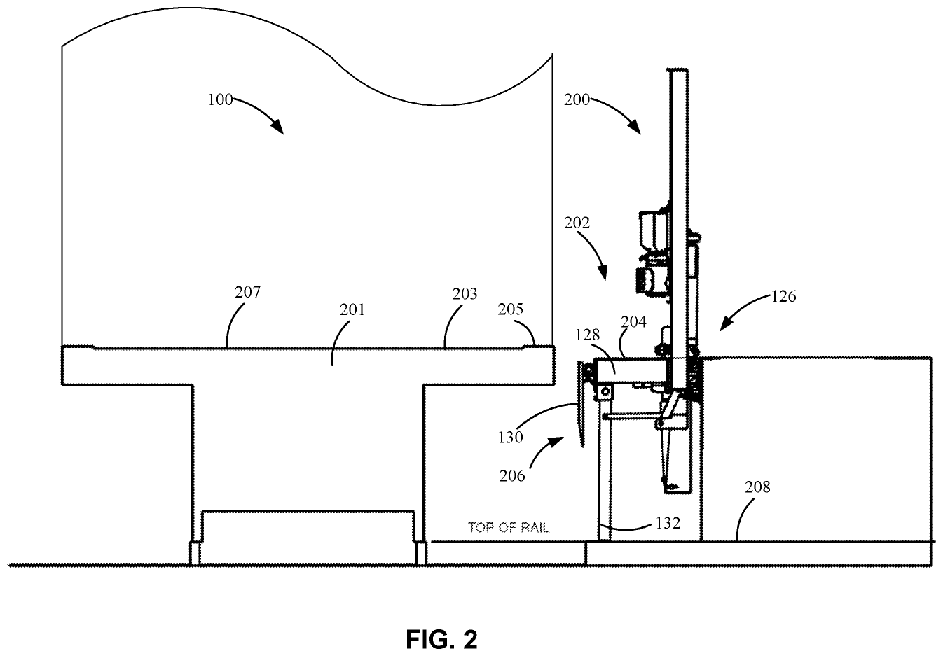

FIG. 2 is a side view of the example loading bay 100 of FIG. 1 showing an example railcar 201 parked at the loading bay 100 and the railcar ramp system 102 in a first operational position 200. When the railcar 201 is parked at the loading bay 100 adjacent the doorway 106 (FIG. 1), a height differential (e.g., a gap or vertical gap in the orientation of FIG. 2)) can exist between the platform 108 and a cargo area 203 of the railcar 201 (e.g., a boxcar, etc.). Additionally, a lateral misalignment can exist between the railcar 201 or railcar doorway 205 (e.g., a side doorway) oriented toward the doorway 106 of the loading bay 100 and/or the railcar ramp system 102 in a direction along the longitudinal axis 112 (FIG. 1). To reduce or eliminate a lateral misalignment between the railcar doorway 205 and the railcar ramp system 102, the ramp mover 134 can be employed to move the railcar ramp system 102 laterally in the first direction 114 (FIG. 1) to reduce or eliminate the lateral gap. After the lateral gap is eliminated and/or the railcar doorway 205 is aligned laterally with the railcar ramp system 102, the railcar ramp system 102 can be deployed to span a gap (e.g., a vertical gap in the y-axis direction) between the platform 108 and the cargo area 203 of the railcar 201. For example, the railcar ramp system 102 can be positioned in the first operational position 200.

The first operational position 200 of the illustrated example is an end loading position 202. In the end loading position 202 of the illustrated example, the deck 128 of the leveler 126 is moved (e.g., pivoted) toward the railcar 201 in the second direction 118 (FIG. 1) such that an upper surface 204 of the deck 128 aligns (e.g., is substantially parallel) relative to an upper surface 207 of the cargo area 203 of the railcar 201. The lip 130 of the leveler 126 is in a stowed position 206 (e.g., a retracted position). The end loading legs 132 are positioned to engage a lower surface 208 of the platform 108 to support the deck 128.

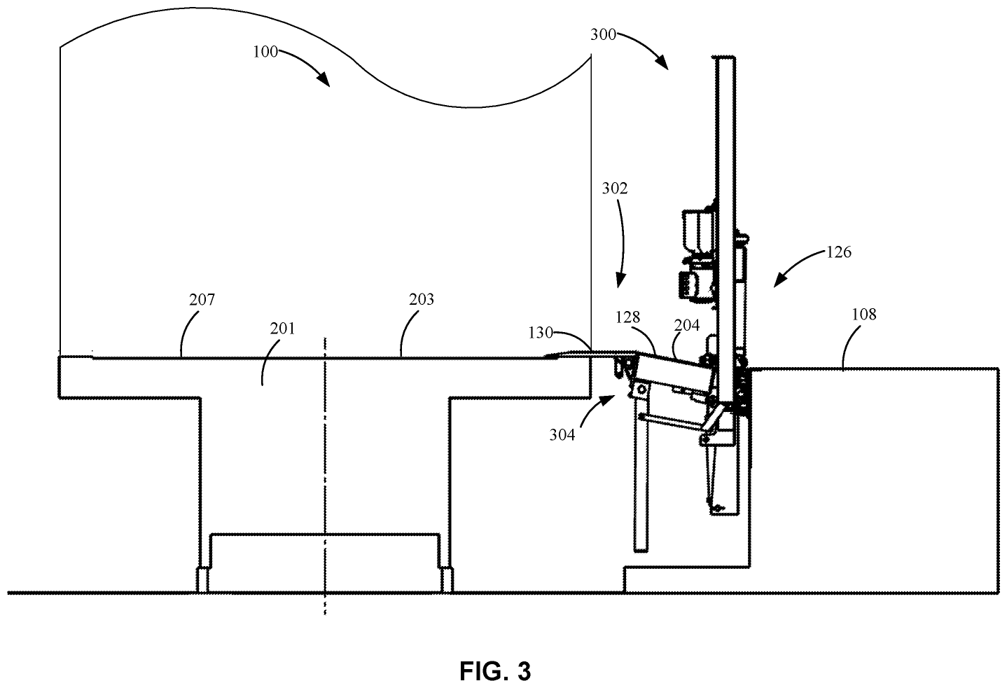

FIG. 3 is a side view of the loading bay 100 of FIG. 1 showing the example railcar 201 parked at the loading bay 100 and the railcar ramp system 102 in a second operational position 300. After the lateral gap is eliminated and/or the railcar doorway 205 is aligned laterally with the railcar ramp system 102, the railcar ramp system 102 can be deployed to span a gap (e.g., a vertical gap in the y-axis direction and/or a horizontal gap in the z-axis direction) between the platform 108 and the cargo area 203 of the railcar 201. For example, the railcar ramp system 102 can be positioned in the second operational position 300. The second operational position 300 of the illustrated example is an example standard loading position 302. In the standard loading position 302 of the illustrated example, the deck 128 is moved toward the railcar 201 in the second direction 118 (FIG. 1) where the upper surface 204 of the deck 128 is non-parallel relative to the upper surface 207 of the railcar 201. Additionally, the lip 130 is in an example extended position 304 and positioned at least partially on the upper surface 207 of the cargo area 203 to provide a continuous pathway (e.g., to be traversed by a vehicle) between the cargo area 203 and the platform 108.

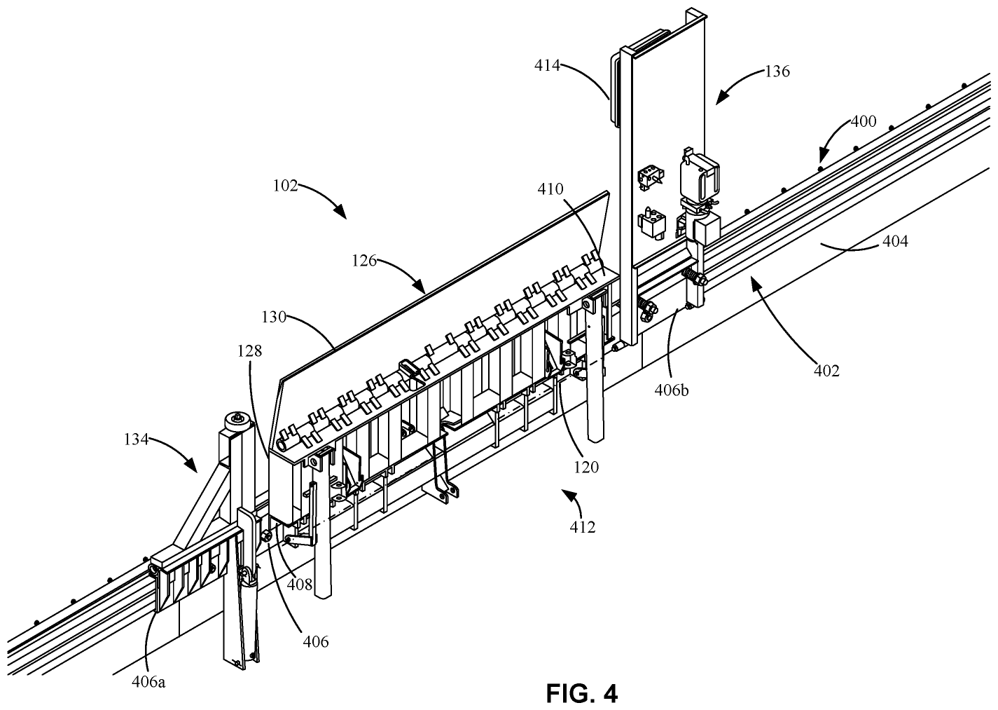

FIG. 4 is a perspective view of the railcar ramp system 102 of FIGS. 1-3. The railcar ramp system 102 includes the leveler 126, the ramp mover 134 and the control panel 136. To slidably couple the railcar ramp system 102 to the platform 108, the loading bay 100 and/or the railcar ramp system 102 of the illustrated example employs a track system 400. The track system 400 of the illustrated example includes guide rails 402 mounted to a plate 404. In some examples, the guide rails 402 can be from just a few feet longer than a railcar ramp in width and up to hundreds of feet long and/or any desired length and/or width (e.g., 35 feet long, 150 feet long, etc.). The plate 404 of the illustrated example couples to the front face 108a (FIG. 1) of the platform 108. When coupled to the platform 108, the guide rails 402 of the illustrated example are substantially parallel relative to the rails 110, the longitudinal axis 112 and/or the building wall 104 (FIG. 1).

To enable the railcar ramp system 102 to move relative to the platform 108 along the guide rails 402, the track system 400 and/or the railcar ramp system 102 of the illustrated example includes a carriage 406. The carriage 406 of the illustrated example is an elongated body having a first end 406a and a second end 406b opposite the first end 406a. Specifically, the leveler 126, the ramp mover 134 and the control panel 136 are coupled (e.g., mounted) to the carriage 406. In the illustrated example, the ramp mover 134 is coupled adjacent the first end 406a of the carriage 406, the control panel 136 is coupled adjacent the second end 406b of the carriage 406, and the leveler 126 is coupled between the first end 406a and the second end 406b of the carriage 406 (e.g., between the ramp mover 134 and the control panel 136). However, in other examples, the control panel 136 can be positioned between the leveler 126 and the ramp mover 134, the ramp mover 134 can be positioned between the leveler 126 and the control panel 136, and/or the control panel 136 can be positioned adjacent the first end 406a of the carriage 406 and the ramp mover 134 can be positioned adjacent the second end 406b of the carriage 406. As the carriage 406 moves along the guide rails 402, the railcar ramp system 102 (e.g., the leveler 126, the ramp mover 134 and the control panel 136) moves along the guide rails 402 (e.g., in the first direction 114).

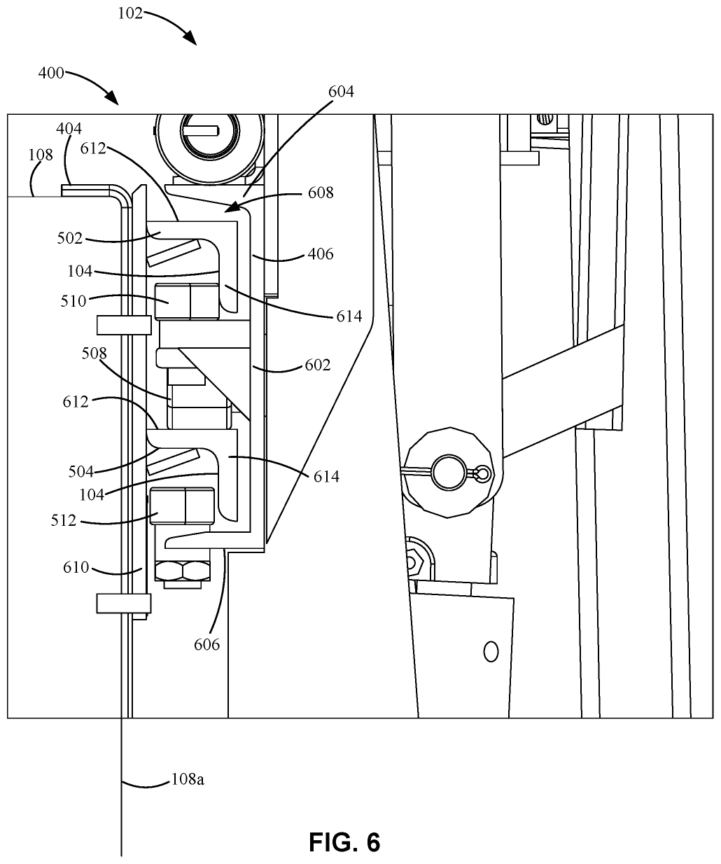

The deck 128 of the leveler 126 of the illustrated example is pivotally coupled (e.g., pivotally hinged) along a back edge 408 (e.g., a header) of the deck 128 to the carriage 406. To vary the height of a front edge 410 of the deck 128 of the leveler 126 relative to the cargo area 203 of the railcar 201, a drive system operates leveler 126. Specifically, the drive system causes the deck 128 to pivot or rotate about the pivot axis 120 between a stored position 412 shown in FIG. 4 and the first operating position 200 of FIG. 2 or the second operating position 300 of FIG. 3. The lip 130 of the illustrated example is pivotally coupled to the front edge 410 of the deck 128. To span a gap between the front edge 410 of the deck 128 and the cargo area 203, the drive system causes the lip 130 to move between the stowed position 206 of FIG. 6 to the extended position 304 of FIG. 3 such that the lip 130 extends outward from the front edge 410 of the deck 128 to engage the upper surface 207 of the cargo area 203. For example, movement of the leveler (e.g., the deck 128 and/or the lip 130) can be controlled electro-hydraulically from a push-button station supported by the control panel 136. Pushing a button on a control box 414 can operate the leveler 126 between the stored position 412 and the first operating position 200 and/or the second operating position 300 (i.e., to lower and/or raise the leveler 126). In some examples, the lip 130 can be extended or retracted at any time during a cycle from the push-button station. A hydraulic railcar ramp system can be powered by an electrohydraulic power unit with submerged hydraulic pump and direct connect reservoir. The system can be controlled by one or more solenoid valves (e.g., four solenoid valves). Although not shown, one or more electrical wires, fluid lines (e.g., hydraulic oil lines, pneumatic air lines, etc.) can be routed within the carriage 406 (e.g., a lower surface of the guide) between the leveler 126, the ramp mover 134 and/or the control panel 138 such that one or more electrical wires, fluid lines, etc. do not impede or hinder operation of the railcar ramp system 102 (e.g., as the railcar ramp system 102 moves between the stored position 412, the first operational position 200, the second operational position 300, and/or moves along the first direction 114 of FIG. 1).

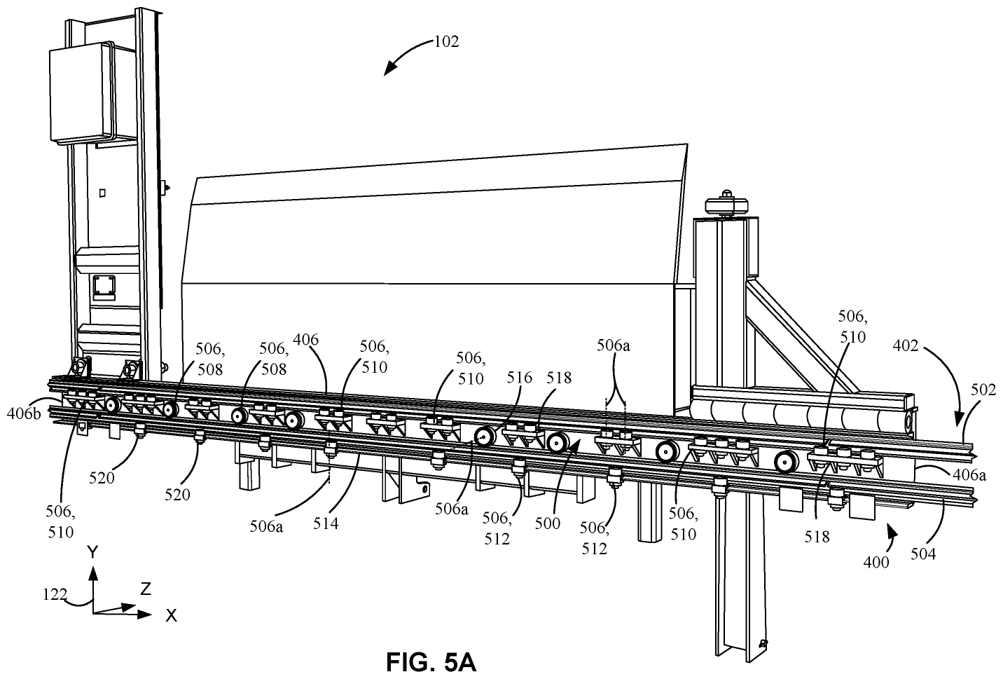

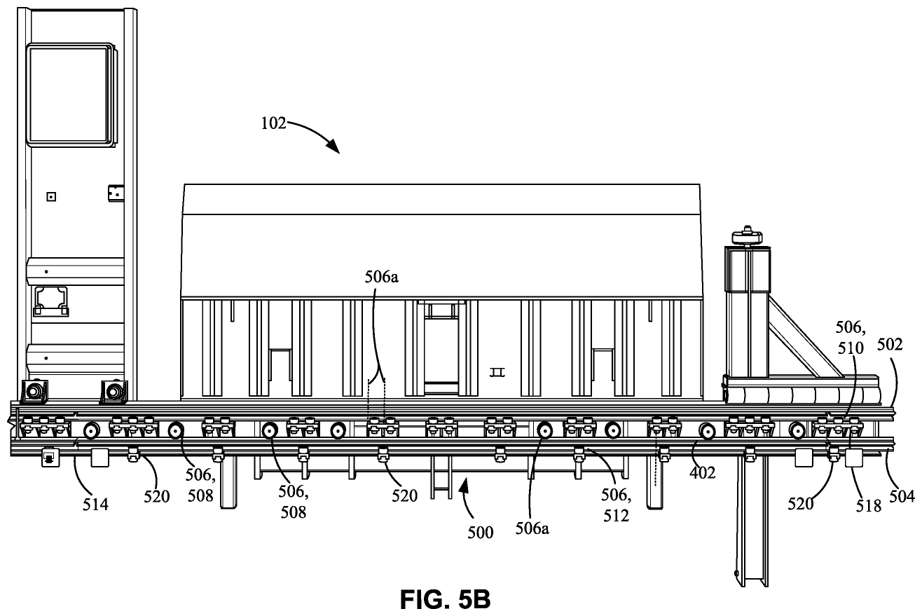

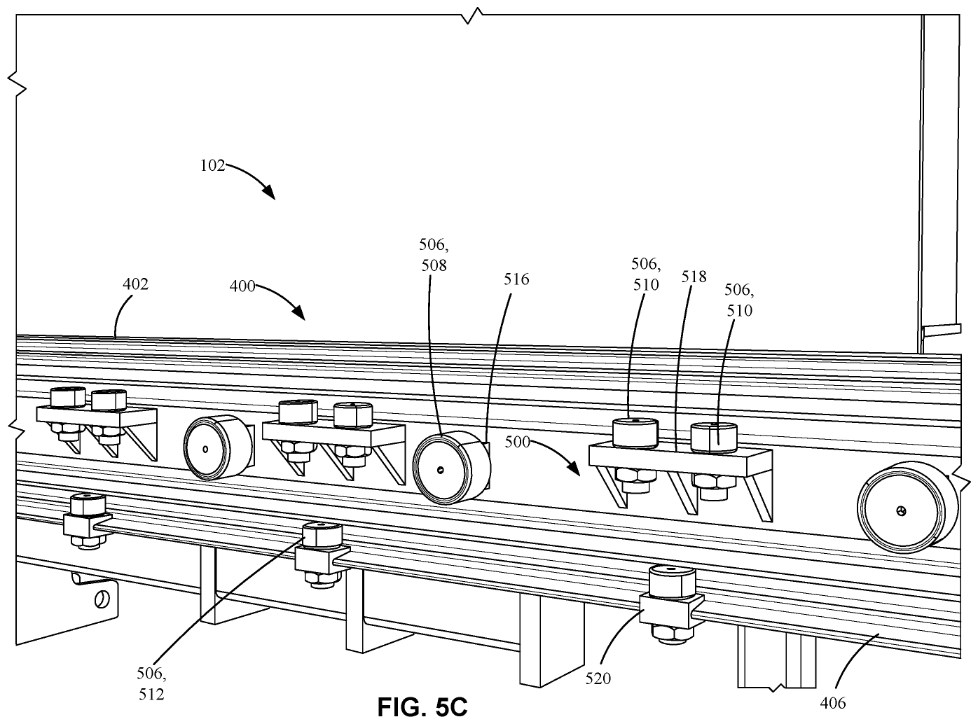

FIG. 5A is a perspective, rear view of railcar ramp system 102 of FIGS. 1-4. The platform 108 and the plate 404 are omitted for clarity. FIG. 5B is a side, rear view of FIG. 5A. FIG. 5C is a partial, enlarged view of FIG. 5A. Referring to FIGS. 5A-5C, the guide rail 402 of the track system 400 includes a first rail 502 and a second rail 504 spaced from the first rail 502. However, in some examples, the track system 400 employs three rails, four rails, etc. Specifically, the first rail 502 is spaced from the second rail 504 in a direction along the y-axis 122 (e.g., a vertical direction in the orientation of FIGS. 5A-5C). To enable the carriage 406 to move laterally in the first direction 114, the track system 400 of the illustrated example employs a slide assembly 500. The slide assembly 500 of the illustrated example interacts with the guide rail 402 (e.g., the first rail 502 and the second rail 504). The slide assembly 500 of the illustrated example is a plurality of rollers 506. In other examples, the slide assembly 500 can include bearings, slide plates, guides, and/or any other structure to enable movement of the carriage 406 in the first direction 114.

The rollers 506 of the illustrated example are rotatably coupled relative to the carriage 406. Specifically, each roller 506 includes a rotational axis 502a. Thus, each of the rollers 506 rotates or spins about its respective the rotational axis 502a. The rollers 506 of the illustrated example includes first rollers 508, second rollers 510 and third rollers 512. The first rollers 508 are oriented relative to the second rollers 510 and the third rollers 512 such that the rotational axes 506a of the first rollers 508 are non-parallel (e.g., perpendicular) relative to rotational axes 506a of the second rollers 510 and the third rollers 512. Additionally, the rotational axes 506a of the second rollers 510 are parallel relative to the rotational axes 506a of the third rollers. The first rollers 508 and the second rollers 510 are positioned or coupled to the carriage 406 in an alternating pattern between the first end 406a and the second end 406b of the carriage 406. The third rollers 512 are positioned or coupled to a lower edge 514 of the carriage 406.

Each of the first rollers 508 is coupled to the carriage 406 via a first bracket 516. The first bracket 516 is mounted to the carriage 406 and the first bracket 516 rotatably supports and/or couples the first rollers 508 and the carriage 406. Each of the second rollers 510 is coupled to the carriage 406 via a second bracket 518. The second bracket 518 is mounted or coupled (e.g., welded) to the carriage 406 (e.g., an inner surface of the carriage 406) and the second bracket 518 rotatably couples the second rollers 510 relative to the carriage 406. The second bracket 518 of the illustrated example can each support either two rollers or three rollers. However, in other examples, the second bracket 518 can support any number of second rollers 510 (e.g., one of the second rollers 510, four second rollers 510, etc.). Each of the third rollers 512 is coupled to the carriage 406 via a third bracket 520. The third bracket 520 is mounted or coupled (e.g., welded) to the carriage 406 (e.g., an inner surface of the carriage 406) and the third bracket 520 rotatably couples the third rollers 512 relative to the carriage 406. The third bracket 520 is coupled to the lower edge 514 of the carriage 406. For example, the lower edge 514 of the illustrated example includes a plurality of notches or slots to receive the third brackets 520.

FIG. 6 is a cross-sectional side view of the track system 400 of the example railcar ramp system 102 of FIGS. 1-4, and 5A-5C. The carriage 406 of the illustrated example has a face plate 602, a first flange 604 and a second flange 606. The first flange 604 and the second flange 606 protrude from the face plate 602 to define a cavity 608 therebetween. The rollers 506 and the guide rail 402 (e.g., the first rail 502 and the second rail 504) are positioned in the cavity 608. The carriage 406 of the illustrated example has a C-shaped, cross-sectional shape. However, in other examples, the carriage 406 can have any other suitable shape. The face plate 602 of the illustrated example is substantially parallel relative to the front face 108a of the platform 108 and the first flange 604 and the second flange 606 extend toward the plate 404 of the platform 108.

The guide rail 402 of the illustrated example is mounted to the plate 404 via a mounting plate 610. Specifically, the first rail 502 and the second rail 504 are mounted or fixed (e.g., welded) to the mounting plate 610. In turn, the mounting plate 610 is coupled to the plate 404 via a plurality of fasteners (e.g., anchors, bolts, etc.). The first rail 502 and the second rail 504 each includes a first leg 612 and a second leg 614. The first leg 612 is oriented perpendicular or non-parallel relative to the front face 108a and the second leg 614 is oriented substantially parallel relative to the front face 108a. Thus, the first leg 612 is perpendicular (e.g., at an approximately 90-degree angle) relative to the second leg 614.

When coupled to the platform 108, the first rollers 508 ride along or on (e.g., directly on) the first leg 612 of the second rail 504. Thus, the first rollers 508 move along a horizontal surface parallel relative to the longitudinal axis 112 (FIG. 1) when the railcar ramp system 102 moves laterally relative to the platform 108. The second rollers 510 are positioned between the mounting plate 610 and the second leg 614 of the first rail 502 and the third rollers 512 are positioned between the mounting plate 610 and the second leg 614 of the second rail 504. The second rollers 510 can move (e.g., engage) along a surface of the mounting plate 610 and/or the second leg 614 of the first rail 502. and the third rollers 512 can move (e.g., engage) along the surface of the mounting plate 610 and/or the second leg 614 of the second rail 504. Thus, the second rollers 510 and the third rollers 512 move along or between vertical surfaces parallel relative to the front face 108a of the platform 108 (e.g., perpendicular relative to the longitudinal axis 112).

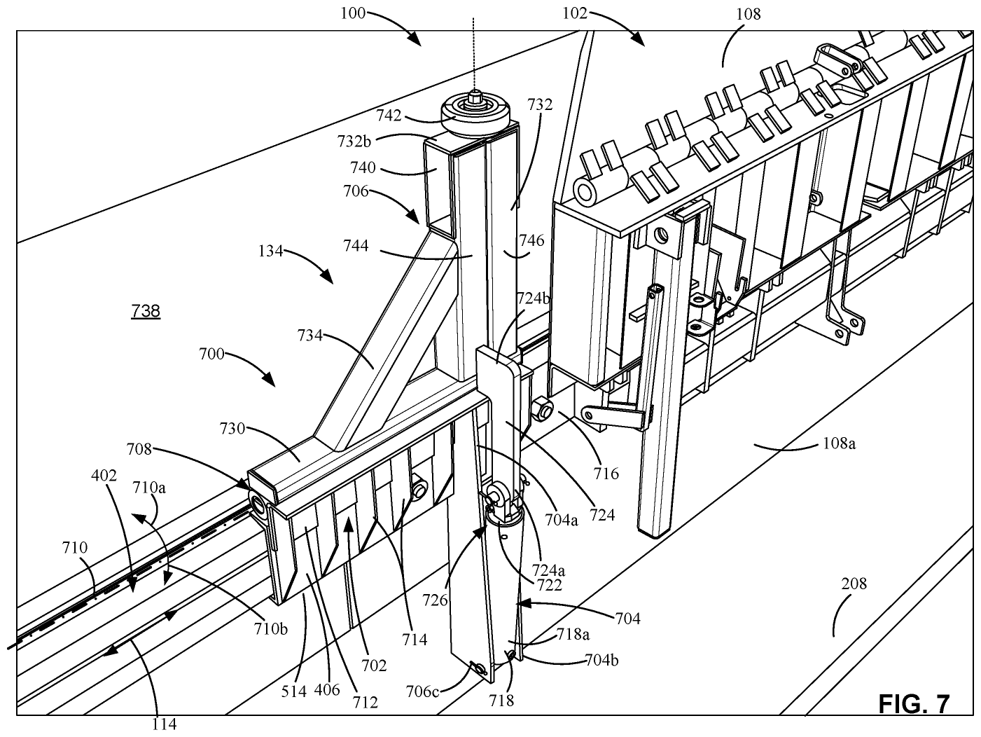

FIG. 7 is a partial, perspective view of the railcar ramp system 102 of FIGS. 1-6. The ramp mover 134 of the illustrated example includes a frame 700 including guide mounting frame 702, a drive frame 704, and a drop arm frame 706. The ramp mover 134 of the illustrated example includes a hinge 708 (e.g., a pivot hinge, a piano hinge, etc.) to pivotally couple the drop arm frame 706 relative to the guide mounting frame 702 and/or the carriage 406. Specifically, the drop arm frame 706 pivots relative to the guide mounting frame 702, the carriage 406 and/or the platform 108 about a pivot axis 710 defined by the hinge 708.

The guide mounting frame 702 couples (e.g., directly attaches) the ramp mover 134 and the carriage 406. In the illustrated example, the guide mounting frame 702 includes a guide mounting plate 712 (e.g., an L-shaped plate) and a plurality of ribs 714. The guide mounting plate 712 and/or the ribs 714 couple to an outer or front surface 716 of the face plate 602 of the guide. For example, the guide mounting frame 702 can be coupled to the carriage 406 via welding, fasteners, and/or any other fastener(s). In some examples, the carriage 406 and the guide mounting frame 702 can be integrally formed as a unitary structure (e.g., a single structure).

The drive frame 704 of the illustrated example is coupled to the carriage 406 and/or the guide mounting frame 702. For example, the drive frame 704 can couple to the guide mounting frame 702 and/or the carriage 406 via welding, fasteners, and/or any other suitable fastener(s). The drive frame 704 projects away from the lower edge 514 toward the lower surface 208 of the platform 108. Specifically, the drive frame 704 has a first end 704a coupled to the carriage 406 and/or the guide mounting frame 702 and a second end 704b opposite the first end 704a that projects past the lower edge 514 of the carriage 406. The drive frame 704 of the illustrated example supports an actuator 718. The actuator 718 includes a cylinder 720 having an end 720a coupled to the second end 704b of the drive frame 704 and a piston 722 coupled to the drop arm frame 706 via a link 724 (e.g., a bar). The link 724 of the illustrated example is a bar having a first end 724a coupled to the piston 722 via a clevis connection 726 and a second end 724b opposite the first end 724a coupled (e.g., welded or fastened) to the drop arm frame 706. The second end 704b of the drive frame 704 includes a slot 706c to enable the end 720a and/or the cylinder 720 to pivot and/or otherwise move along the slot 706c during operation of the actuator 718. In the illustrated example, the actuator 718 is a hydraulic actuator. In some examples, the actuator 718 can be a pneumatic actuator, an electric actuator, a stepper motor, and/or any other suitable actuator. In some examples, a drive (e.g., a motor) and a transmission (e.g., a gear train) can be employed instead of the actuator 718.

The drop arm frame 706 of the illustrated example includes a hinge attachment bar 730 (e.g., a beam, a tube, etc.), a vehicle engaging arm 732, and a cross bar 734 (e.g., a reinforcement bar). The hinge attachment bar 730 is orthogonal relative to the vehicle engaging arm 732, and the cross bar 734 is angled between the hinge attachment bar 730 and the vehicle engaging arm 732. The hinge attachment bar 730 is substantially horizontal and/or parallel relative to the longitudinal axis 112 and/or the front face 108a of the platform 108 and the vehicle engagement arm 732 is substantially vertical and/or perpendicular relative to the longitudinal axis 112 and/or an upper surface 738 of the platform 108. In particular, the vehicle engaging arm 732 projects in a direction away from the hinge attachment bar 730. For example, a first end 732a of the vehicle engaging arm 732 is coupled (e.g., attached) to the hinge attachment bar 730 and a second end 732b opposite the first end 732a projects away from the hinge attachment bar 730. The vehicle engaging arm 732 of the illustrated example includes an opening or socket 740 (e.g., a pocket or recess adjacent the second end 732b) for receiving a vehicle component to move the railcar ramp system 102 along the guide rail 402. For example, the socket 740 can receive a portion of a fork or prong of the fork truck, a prong of a fork truck dolly, and/or any other vehicle for moving the railcar ramp system 102 in the first direction 114. Additionally, to facilitate movement of the ramp mover 134 along the upper surface 738 of the platform 108, the vehicle engaging arm 732 of the illustrated example includes a wheel 742 (e.g., a rubber tire or wheel, an air-filled tire, etc.) rotatably mounted to the vehicle engaging arm 732. The vehicle engaging arm 732 of the illustrated example includes a first beam or bar 744 (e.g., a first tube) coupled to or adjacent a second beam or bar 746. Actuation of the actuator 718 causes the link 724 to move or rotate the drop arm frame 706 about the pivot axis 710 of the hinge 708 between a first rotational direction 708a and a second rotational direction 710b opposite the first rotational direction 710a.

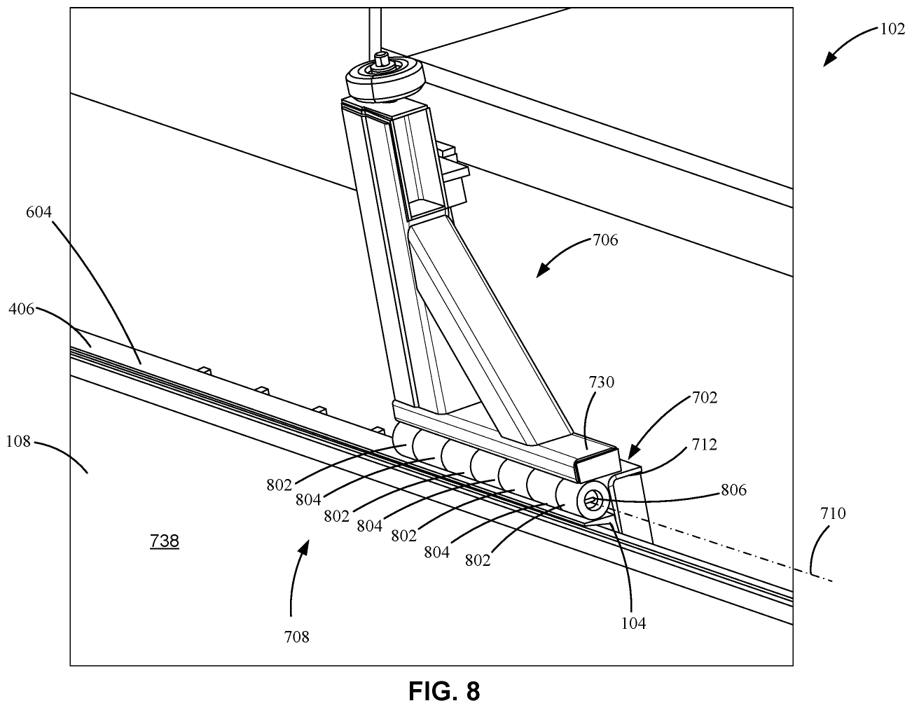

FIG. 8 is a perspective, rear view of the example ramp mover 134 of FIGS. 1-7. The drop arm frame 706 of the example ramp mover 134 of the illustrated example is pivotally coupled to the carriage 406 and/or the guide mounting frame 702 via the hinge 708. The hinge 708 of the illustrated example includes a first plurality of knuckles or barrels 802 and a second plurality of knuckles or barrels 804 interweaved or meshed with the first plurality of barrels 802. A pin 806 interlocks the first barrels 802 and the second barrels 804 and defines the pivot axis 710. The illustrated example shows four of the first barrels 802 and three of the second barrels 804. However, in other examples, more or less barrels than shown can be employed. In the illustrated example, the first barrels 802 are coupled (e.g., directly attached) to the carriage 406 and/or the guide mounting frame 702. For example, the first barrels 802 can be coupled or attached (e.g., via welding) to the first flange 604 of the carriage 406 and/or the guide mounting plate 712 of the guide mounting frame 702. In some examples, the first barrels 802 are coupled to the guide mounting plate 712 and are not coupled to the carriage 406. In some examples, the first barrels 802 are coupled to the carriage 406 and are not coupled to the guide mounting plate 712. In some examples, the first barrels are attached to the carriage 406 and the guide mounting plate 712. Likewise, the second barrels 804 are coupled (e.g., directly attached) to the drop arm frame 706. In particular, the second barrels 804 are coupled to the hinge attachment bar 730. In particular, the second barrels 804 are coupled to a lower surface (e.g., a bottom surface) of the hinge attachment bar 730. Thus, the hinge 708 of the illustrated example is positioned between the hinge attachment bar 730 and the carriage 406. Thus, because the first barrels 802 are attached to the carriage 406 and/or the guide mounting plate 712 and the second barrels 804 are attached to the hinge attachment bar 730, the hinge 708 enables rotation of the drop arm frame 706 about the pivot axis 710 relative to the upper surface 738 of the platform 108.

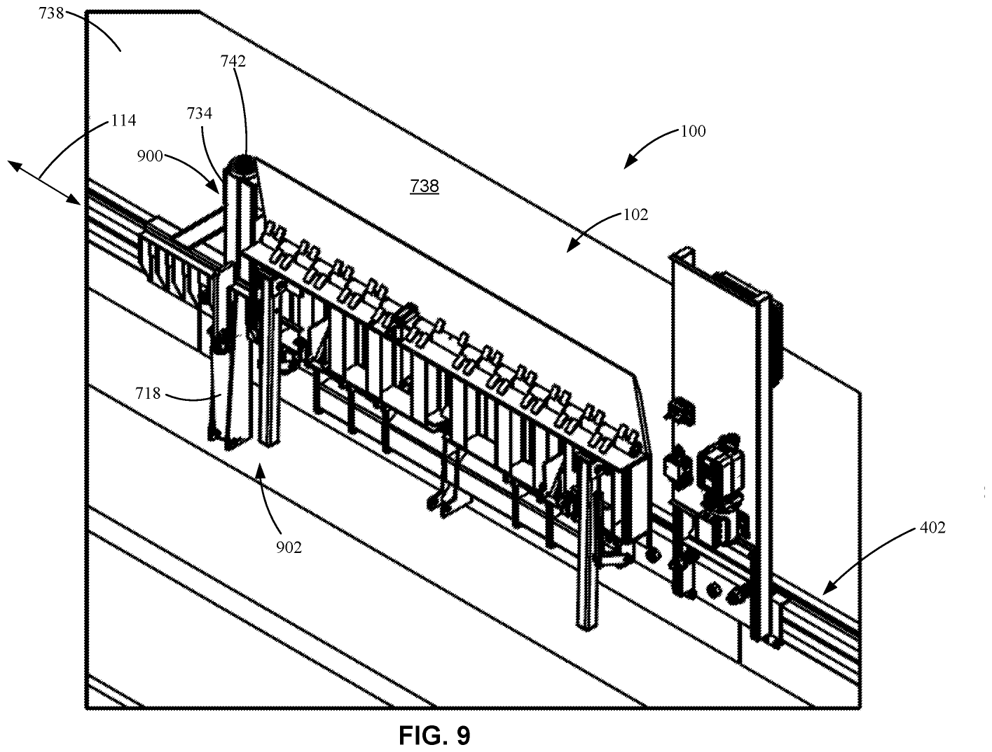

FIG. 9 is a perspective view of the railcar ramp system 102 of FIGS. 1-8. Specifically, the ramp mover 134 of the illustrated example is shown in a stored position 900. In the stored position 900, the actuator 718 is a retracted position 902. As a result of the actuator 718 being in the retracted position 902, the link 724 causes the drop arm frame 706 to move to the stored position 900, in which the wheel 742 is lifted away or positioned away from the upper surface 738 of the platform 108. In other words, the actuator 718 applies a downward force that causes the drop arm frame 706 to move or pivot via the hinge 708 to the stowed position 900. In the stowed position 900, the drop arm frame 706 is substantially vertical relative to the upper surface 738. In other words, the socket 740 of the drop arm frame 706 is elevated away from the upper surface 738 such that a vehicle is not able to engage the drop arm frame 706 and move the ramp mover in the first direction 114. Thus, in the stowed position 900, the drop arm frame 706 provides a lock to prevent movement of the carriage 406, the leveler 126 and/or the control panel 136 in the first direction 114.

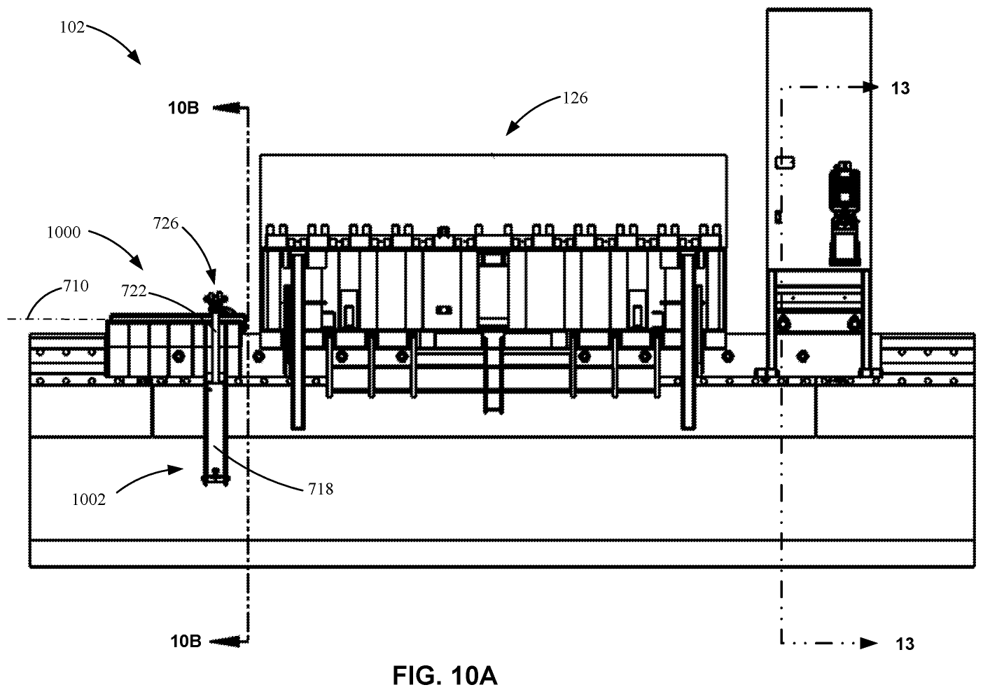

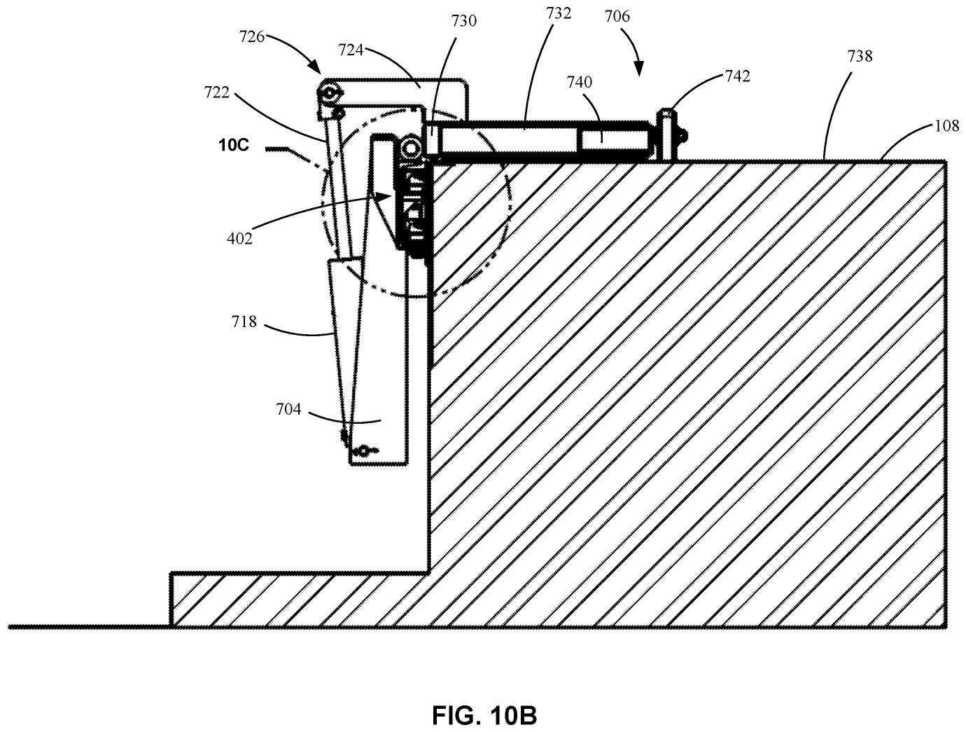

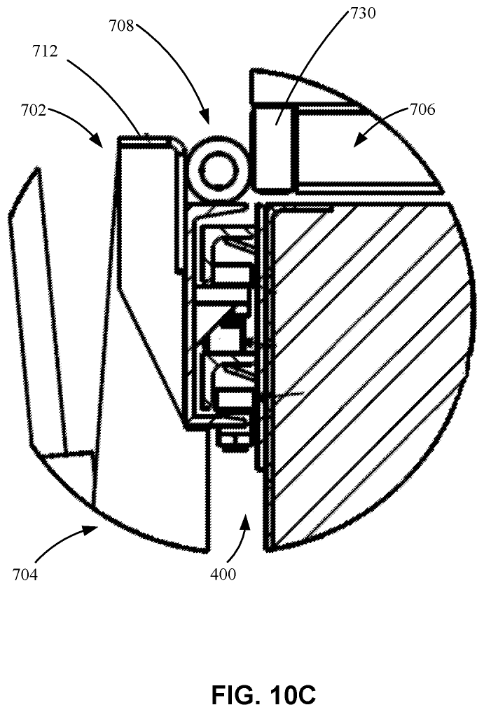

FIG. 10A is a front view of the railcar ramp system 102 of FIGS. 1-8. FIG. 10B is a side view of the railcar ramp system 102 of FIG. 10A. FIG. 10C is an enlarged portion of the railcar ramp system 102 of FIG. 10B. Specifically, the ramp mover 134 of FIGS. 10A-10C is shown in an active position 1000. In the active position 1000, the actuator 718 is an extended position 1002 (e.g., a fully extended position). Operation of the actuator 718 can be commanded via the control box of the control panel 136. Thus, a push-button or other user interface can be provided on the control panel 136 to control actuation of the actuator 718 between the retracted position 902 and the extended position 1002. In the extended position 1002, the clevis connection 726 (e.g., a clevis joint) enables the link 724 to pivot relative to the piston 722 which allows the drop arm frame 706 (e.g., a vehicle engagement frame) to lay or move substantially parallel relative to the upper surface 738 of the platform 108. Thus, the drop arm frame 706 of the illustrated example moves or pivots approximately 90 degrees about the pivot axis 710 when the ramp mover 134 moves between the stored position 900 and the active position 1000.

As a result of the actuator 718 being in the extended position 1002, the link 724 causes the drop arm frame 706 to move to the active position 1000, in which the wheel 742 is engaged with the upper surface 738 of the platform 108. In other words, the actuator 718 applies an upward force to the link 724 that causes the drop arm frame 706 to move or pivot about the pivot axis 710 of the hinge 708 in a first rotational direction 710a (e.g., a counterclockwise direction) to the active position 1000. In the active position 1000, the socket 740 is provided adjacent to the upper surface 738 such that a vehicle can engage the drop arm frame 706 and move the ramp mover in the first direction 114. Thus, in the active position 1000, the drop arm frame 706 enables movement of the carriage 406, the leveler 126 and/or the control panel 136 in the first direction 114. Engagement between the wheel 742 and the upper surface 738 reduces friction and/or improves movement between the drop arm frame 706 and the upper surface 738 when the ramp mover 134 is engaged via a vehicle (e.g., a power industrial lift truck) and moves the railcar ramp system 102 (e.g., linearly) along the guide rail 402. The socket 740 of the illustrated example can receive a lift truck fork to move the carriage 406 in the first direction 114 along the guide rail 402. When engaged by a vehicle (e.g., lift truck), the vehicle (e.g., lift truck) can move the carriage 406 (e.g., the ramp mover 134, the leveler 126, and the control panel 136) along the guide rails 402 via the track system 400. The socket 740 of the illustrated example has a square shaped perimeter or opening. However, in some examples, the socket 740 can have a rectangular shape and/or any other desired shape. Additionally, the socket 740 is dimensioned to receive the fork of a lift truck (e.g., can have a width between approximately 6 inches and 2 feet and a length of between approximately 6 inches and 2 feet).

After the leveler 126 is positioned relative to the railcar 201 to a desired lateral position, the actuator 718 can be retracted to the retracted position 902 of FIG. 9 to cause the drop arm frame 706 to pivot away from the upper surface 738 to the vertical position to restrict or prevent movement of the carriage 406 in the first direction 114 along the guide rail 402.

In some examples, the drop arm frame 706 can be moved between the stored position 900 and the active position 1000 manually. For example, a lock pin can be employed to maintain the drop arm frame 706 in the stored position 900. Rotation of the drop arm frame 706 can be enabled by removing a lock pin and manually rotating the drop arm frame 706 about the pivot axis 710 to cause the wheel 742 to engage the upper surface 738 of the platform 108.

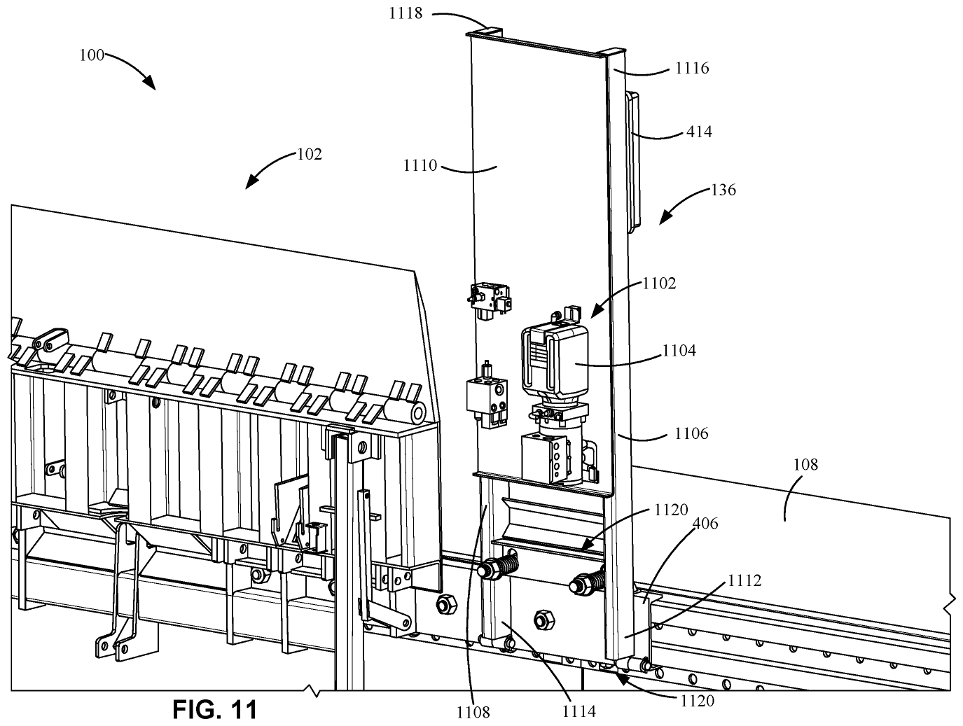

FIG. 11 is a perspective view of the railcar ramp system 102 of FIGS. 1-9. The control panel 136 of the illustrated example supports electronic components 1102 including the control box 414, a power unit and valving system 1104 and/or other electronic components for operating the leveler 126 and/or the ramp mover 134. The control panel 136 of the illustrated example includes a first post 1106 (e.g., a beam, a mast, etc.), a second post 1108 (e.g., a beam, a mast, etc.), and a panel 1110 (e.g., a plate, sheet metal, a board, etc.). The panel 1110 is coupled to the first post 1106 and the second post 1108 to span a distance therebetween. The control panel 136 of the illustrated example is coupled to the carriage 406. Specifically, the control panel 136 is coupled to the carriage 406 at respective first ends 1112, 1114 of the first post 1106 and the second post 1108. Respective second ends 1116, 1118 of the first post 1106 and the second post 1108 project upward or vertically from the carriage 406. The respective second ends 1116, 1118 are free moving ends (e.g., not fixed or attached to structure) and can move or pivot relative to the carriage 406 and/or the first ends 1112, 1114, respectively. The control panel 136 of the illustrated example includes a deflection system 1120 to configure the control panel 136 as an impactable mast, post, beam, or other structure. As used herein, “impactable mast” means that the control panel 136 can flex, deflect, or pivot relative to the carriage 406 and/or platform 108 when subject to impacts (e.g., inadvertent impacts) by a vehicle (e.g., a forklift). In other words, the control panel 136 does not rip off or break from the carriage 406 and/or the platform 108 if impacted by a vehicle.

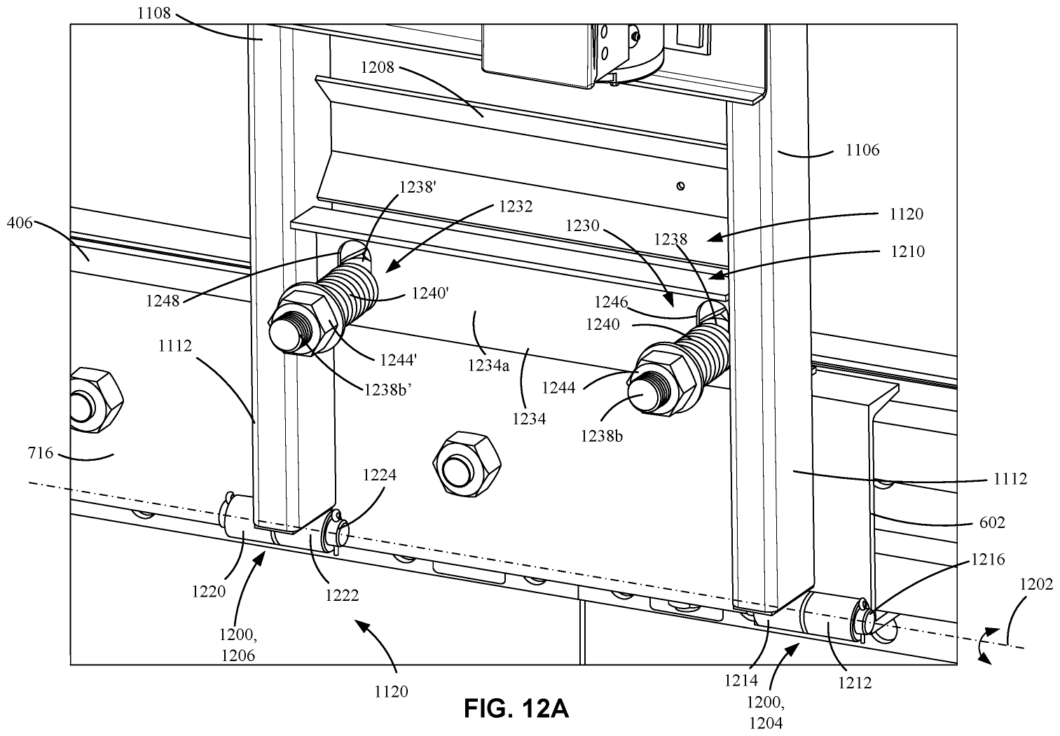

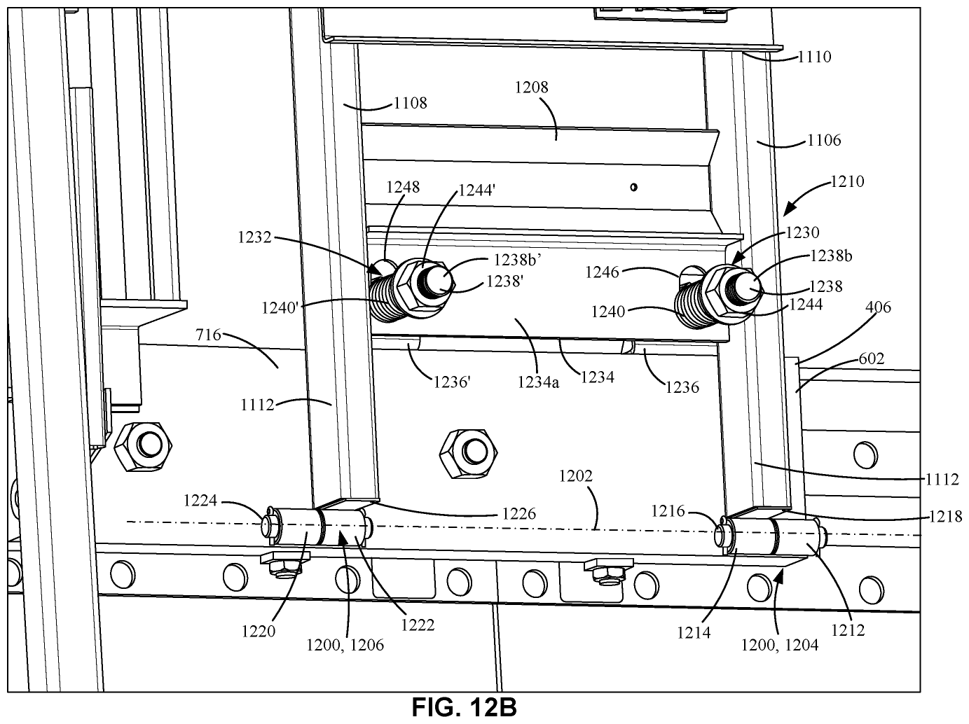

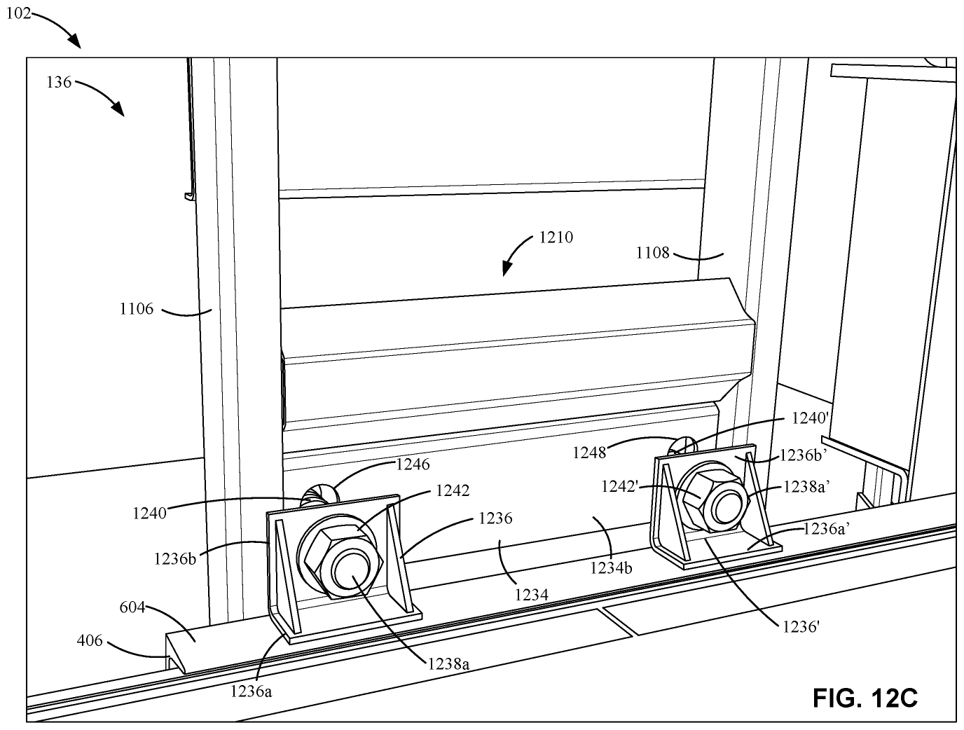

FIG. 12A is an enlarged, front view of the control panel 136 of FIG. 11. FIG. 12B is another enlarged, front view of the control panel 136. FIG. 12C is an enlarged, rear view of the control panel 136 of FIG. 11.

Referring to FIGS. 12A-12C, the deflection system 1120 of the control panel 136 of the illustrated example includes a pivot hinge 1200 and a biasing assembly 1210. For example, the control panel 136 of the illustrated example is pivotally coupled to the carriage 406 via the pivot hinge 1200 that enables the control panel 136 to pivot relative to the carriage 406 and/or the platform 108 about a pivot axis 1202 defined by the pivot hinge 1200. The pivot hinge 1200 of the illustrated example includes a first pivot hinge 1204 and a second pivot hinge 1206. The first pivot hinge 1204 pivotally couples the first post 1106 and the carriage 406 and the second pivot hinge 1206 pivotally couples the second post 1108 and the carriage 406. Although the pivot hinge 1200 of the illustrated example includes a first pivot hinge 1204 and a second pivot hinge 1206, the first pivot hinge 1204 and the second pivot hinge 1206 enable the first post 1106 and the second post 1108 to move or pivot simultaneously relative to the carriage 406 about the pivot axis 1202 because the first post 1106 is coupled to the second post 1108 via the panel 1110, an impact guard 1208 and/or a biasing assembly 1210.

The first pivot hinge 1204 of the illustrated example includes a first knuckle 1212, a second knuckle 1214 and a first pin 1216. The first knuckle 1212 of the first pivot hinge 1204 is coupled to the carriage 406. Specifically, the first knuckle 1212 is attached to the front surface 716 of the face plate 602 of the carriage 406. For example, the first knuckle 1212 is attached or fixed to the carriage 406 via, for example, welding. The second knuckle 1214 is coupled to the first post 1106. In this example, the second knuckle 214 is attached or fixed (e.g., welded) to an end surface 1218 of the first end 1112 of the first post 1106. The first pin 1216 maintains alignment of the first knuckle 1212 and the second knuckle 1214 relative to the pivot axis 1202 to enable the first post 1106 to pivot relative to the carriage 406 about the pivot axis 1202.

The second pivot hinge 1206 is substantially similar or identical to the first pivot hinge 1204 (e.g., a mirror or the first pivot hinge 1204). For example, the second pivot hinge 1206 includes a third knuckle 1220, a fourth knuckle 1222, and a second pin 1224. The third knuckle 1220 of the second pivot hinge 1206 is coupled to the carriage 406. Specifically, the third knuckle 1220 is attached to the front surface 716 of the face plate 602 of the carriage 406. For example, the third knuckle 1220 is attached or fixed to the carriage 406 via, for example, welding. The fourth knuckle 1222 is coupled to the second post 1108. In this example, the fourth knuckle 1222 is attached or fixed (e.g., welded) to an end surface 1226 of the first end 1114 of the second post 1108. The second pin 1224 maintains alignment of the third knuckle 1220 and the fourth knuckle 1222 relative to the pivot axis 1202 to enable the second post 1108 to pivot relative to the carriage 406 about the pivot axis 1202.

The biasing assembly 1210 of the illustrated example maintains the control panel 136 in an upright orientation. For example, the biasing assembly 1210 of the illustrated example biases the control panel 136 about the pivot axis 1202 in a direction toward the carriage 406. In this manner, the first ends 1112 of the respective first post 1106 and the second post 1108 are biased into engagement (e.g., direct contact) with the carriage 406 (e.g., the outer surface or front surface 716 of the carriage 406). Thus, when the control panel 136 is deflected or pivoted about the pivot axis 1202 in a direction away from the carriage 406 and/or the platform 108, the biasing assembly 1210 causes the control panel 136 to return to the upright orientation after an impact event.

The biasing assembly 1210 of the illustrated example includes a first spring assembly 1230, a second spring assembly 1232, and a support plate 1234 (e.g., a push plate). Although the biasing assembly 1210 of the illustrated example is shown with a first spring assembly 1230 and a second spring assembly 1232, in some examples, the biasing assembly 1210 can include only a single spring assembly or three or more spring assemblies.

The first spring assembly 1230 of the illustrated example includes a first mounting bracket 1236, a first fastener or screw 1238 (e.g., a bolt), a first spring 1240, a first fastener 1242 (e.g., a nut) and a second fastener 1244 (e.g., a nut). The first spring 1240 of the illustrated example is a coil spring. However, in some examples, the first spring 1240 can be a Belleville springs (e.g., stacked springs), torsion springs, leaf springs, a combination thereof, and/or any other suitable biasing element to bias the control panel to an upright orientation. The first screw 1238 of the illustrated example is a bolt. The first screw 1238 includes threads between a first end 1238a of the first screw 1238 and a second end 1238b of the first screw 1238 opposite the first end 1238a. In some examples, the first screw 1238 has a shank portion (e.g., a non-threaded portion) between the first end 1238a and the second end 1238b. The first end 1238a is threaded to receive the first fastener 1242 and the second end 1238b is threaded to receive the second fastener 1244. Each of the first fastener 1242 and the second fastener 1244 of the illustrated example is a nut and a washer. However, in some examples, the first fastener 1242 and/or the second fastener 1244 can be a clamp, a lock nut, a plate welded to the first screw 1238, and/or any other fastener(s). In some examples, the first screw 1238 can be a rod (e.g., a non-threaded rod) and the first fastener 242 and/or the second fastener 244 can be an end cap attached to the respective ends of the rod (e.g., via welding).

The first mounting bracket 1236 of the first spring assembly 1230 is mounted to the carriage 406. Specifically, the first mounting bracket 1236 is mounted on or to the first flange 604 of the carriage 406. The first mounting bracket 1236 includes a first bracket leg 1236a and a second bracket leg 1236b. The first bracket leg 1236a is orthogonal relative to the second bracket leg 1236b. Specifically, the first bracket leg 1236a is oriented in a horizontal orientation or parallel relative to the first flange 604 of the carriage 406 and the second bracket leg 1236b is oriented in a vertical orientation and/or perpendicular relative to the first flange 604 of the carriage 406. The first spring assembly 1230 is cantilevered from the first mounting bracket 1236. For example, the first end 1238a of the first screw 1238 is fastened or coupled to the first mounting bracket 1236 via the first fastener 1242 and the second end 1238b of the first screw 1238 extends through a first slot 1246 (e.g., an oblong opening) formed in the support plate 1234. The first spring 1240 is supported by the first screw 1238. In other words, the first screw 1238 passes through an open opening of the first spring 1240. The second fastener 1244 couples to the second end 1238b of the first screw 1238 to retain the first spring 1240 coupled to the first screw 1238. In particular, the first spring 1240 is captured between a first side 1234a of the support plate 1234 and the second fastener 1244. The first side 1234a of the support plate 1234 is oriented away from the platform 108 and toward the rail 110 (FIG. 1). Thus, the first spring 1240 is not positioned on a second side 1234b of the support plate 1234 that is oriented toward the first mounting bracket 1236. Thus, the support plate 1234 is positioned between the first spring 1240 and the first mounting bracket 1236.

The second spring assembly 1232 of the illustrated example includes a second mounting bracket 1236′, a second fastener or screw 1238′ (e.g., bolt), a second spring 1240′, a third fastener 1242′ (e.g., a nut) and a fourth fastener 1244′ (e.g., a nut). The second spring 1240′ of the illustrated example is a coil spring. However, in some examples, the second spring 1240′ can be a Belleville springs (e.g., stacked springs), torsion springs, leaf springs, a combination thereof, and/or any other suitable biasing element to bias the control panel to an upright orientation. The second screw 1238′ of the illustrated example is a bolt. The second screw 1238′ includes threads between a first end 1238a′ of the second screw 1238′ and a second end 1238b′ of the second screw 1238′ opposite the first end 1238a′. In some examples, the second screw 1238′ has a shank portion (e.g., a non-threaded portion) between the first end 1238a′ and the second end 1238b′. The first end 1238a′ is threaded to receive the third fastener 1242′ and the second end 1238b′ is threaded to receive the fourth fastener 1244′. Each of the third fastener 1242′ and the fourth fastener 1244′ of the illustrated example is a nut and a washer. However, in some examples, the third fastener 1242′ and/or the fourth fastener 1244′ can be a clamp, a lock nut, a plate welded to the second screw 1238′, and/or any other fastener(s). In some examples, the second screw 1238′ can be a rod (e.g., a non-threaded rod) and the third fastener 242′ and/or the fourth fastener 244′ can be an end cap attached to the respective ends of the rod (e.g., via welding).

The second mounting bracket 1236′ of the second spring assembly 1232 is mounted to the carriage 406. Specifically, the second mounting bracket 1236′ is mounted on or to the first leg 604 of the carriage 406. The second mounting bracket 1236′ includes a first bracket leg 1236a′ and a second bracket leg 1236b′. The first bracket leg 1236a′ is orthogonal relative to the second bracket leg 1236b′. Specifically, the first bracket leg 1236a′ is oriented in a horizontal orientation or parallel relative to the first flange 604 of the carriage 406 and the second bracket leg 1236b′ is oriented in a vertical orientation and/or perpendicular relative to the first flange 604 of the carriage 406. The second spring assembly 1230′ is cantilevered from the second mounting bracket 1236′. For example, the first end 1238a′ of the second screw 1238′ is fastened or coupled to the second mounting bracket 1236′ via the third fastener 1242′ and the second end 1238b′ of the second screw 1238′ extends through a second slot 1248 formed in the support plate 1234. The second spring 1240′ is supported by the second screw 1238′. In other words, the second screw 1238′ passes through an open opening of the second spring 1240′. The fourth fastener 1244′ couples to the second end 1238b′ of the second screw 1238′ to retain the second spring 1240′ coupled to the second screw 1238′. In particular, the second spring 1240′ is captured between the first side 1234a of the support plate 1234 and the fourth fastener 1244′. The second spring 1240′ is not positioned on the second side 1234b of the support plate 1234. Thus, the support plate 1234 is positioned between the second spring 1240′ and the second mounting bracket 1236′. Because the deflection assembly 1120 (e.g., the pivot hinge 1200 and the biasing assembly 1210) are supported by or coupled to the carriage 406, the deflection system 1120 does not impede or obstruct movement of the carriage 406 in the first direction 114 when the carriage 406 is moved along the guide rails 402 via the ramp mover 134.

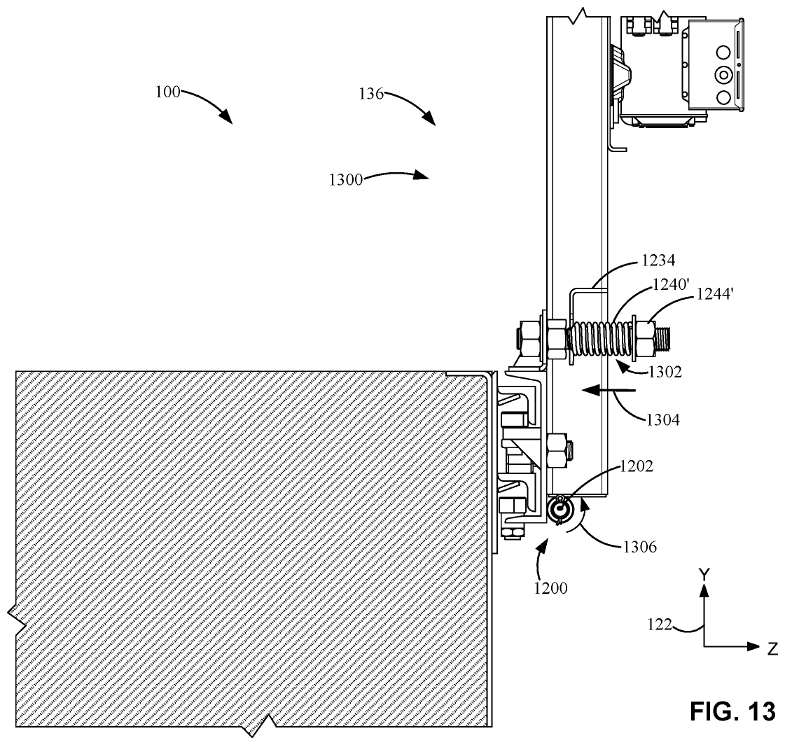

FIG. 13 is a cross-sectional view of the control panel 136 taken along 13-13 of FIG. 10A. The control panel 136 of the illustrated example is shown in an example initial or non-deflected position 1300. In the non-deflected position 1300, the control panel 136 is in an upright orientation. Specifically, the control panel 136 is substantially vertical relative to the platform 108 and/or the front face 108a. For instance, the control panel 136 (e.g., the first post 1106 and the second post 1108) are substantially parallel relative to the front face 108a and/or vertical (e.g., the y-axis 122). As used herein, substantially parallel includes perfectly parallel or almost perfectly parallel. For example, in the non-deflected position 1300, the control panel 136 can be at a small angle relative to vertical (e.g., the y-axis 122) between approximately 0.1 degrees and 10 degrees. For instance, a weight of the control panel 136 can cause the control panel 136 to deflect slightly (e.g., between 0.1 and 10 degrees) relative to vertical or the y-axis 122 when the control panel 136 is in the non-deflected position 1300. In the non-deflected position 1300, the springs 1240, 1240′ are in a first compressed state 1302 between the support plate 1234 and the respective fasteners 1244, 1244′ that apply a first force 1304 against the support plate 1234 to cause the control panel 136 to rotate in a first rotational direction 1306 (e.g., a counterclockwise direction) about the pivot axis 1202 of the pivot hinge 1200 toward the carriage 406. As a result, the first post 1106 and the second post 1108 engage the front surface 716 of the carriage 406.

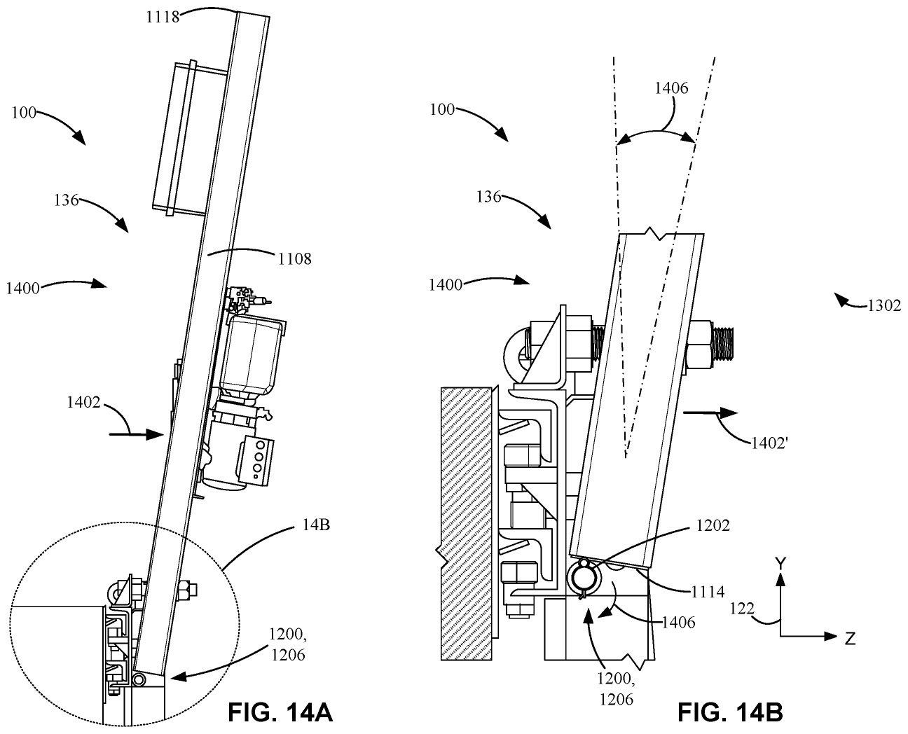

FIG. 14A is a side view of the control panel 136 shown in an example deflected position 1400. FIG. 14B is a partial, enlarged view of FIG. 14B. Referring to FIG. 14B, in the deflected position 1400, the control panel 136 pivots away from platform 108 and/or the carriage 406 via the pivot hinge 1200 when an impact force (e.g., a horizontal force) is imparted to the control panel 136 in a second direction 1402′ away from the platform 108. For example, a vehicle or fork truck can inadvertently engage the control panel 136 when traversing the platform 108. In conventional control panels that are rigidly coupled to the platform, such impact can cause damage to the control panel 136. However, the control panel 136 of the illustrated example deflects to dissipate such forces and reduce or eliminate damage to the control panel 136.

Specifically, the control panel 136 pivots or rotates in a second rotational direction 1404 (e.g., a clockwise direction) about the pivot axis 1202 of the pivot hinge 1200 away from the carriage 406. In the deflected position 1400, the first post 1106 and the second post 1108 detach from the front surface 716 (e.g., an outer surface) of the carriage 406. However, the first post 1106 and the second post 1108 remain attached or and coupled to the carriage 406 via the pivot hinge 1200. In other words, the second ends 1116 and 1118 of the respective first post 1106 and the second post 1108 swing or pivot relative to the pivot hinge 1200 between the deflected position 1400 and the non-deflected position 1300 of FIG. 13. The first ends 1112 and 1114 of the respective first post 1106 and the second post 1108 remain attached to the carriage 406 via the first pivot hinge 1204 and the second pivot hinge 1206. In the deflected position 1400, the control panel 136 can be an angle 1406 relative to vertical or the y-axis 122 of between approximately 5 degrees and 70 degrees. After the impact force 1402 is removed or dissipated, the control panel 136 of the illustrated example returns to the non-deflected position 1300 of FIG. 13.

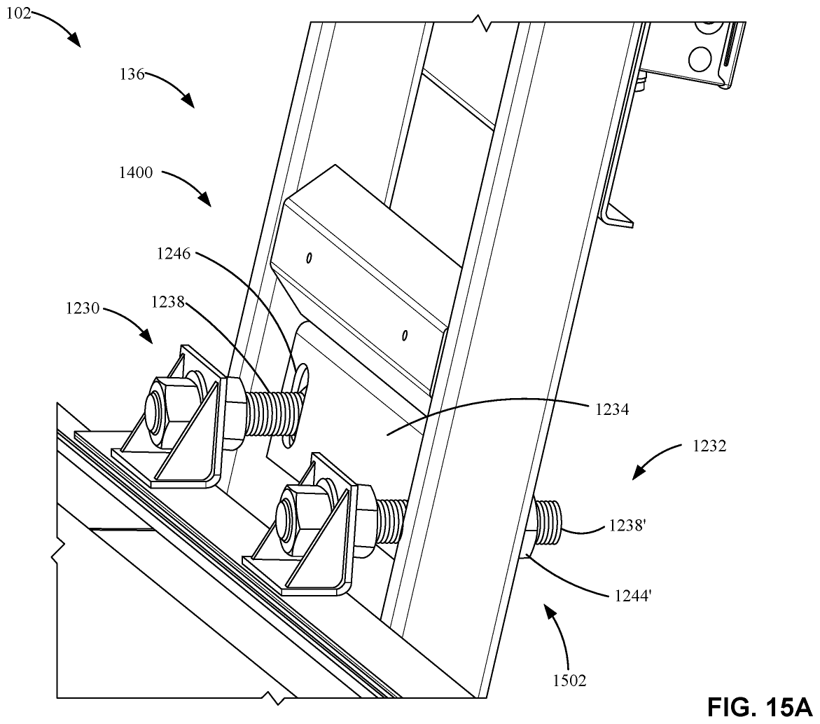

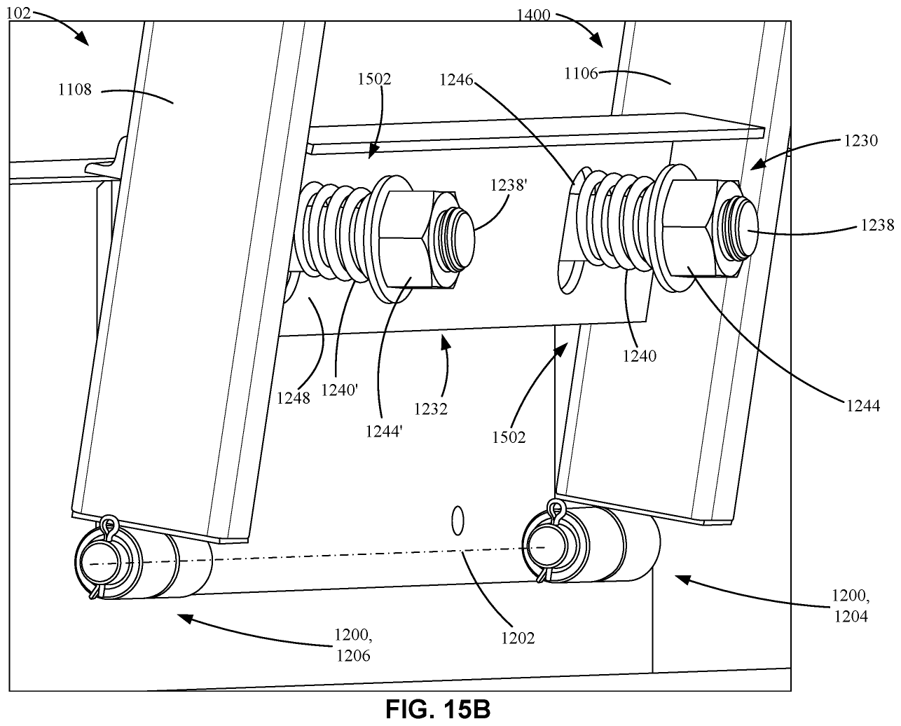

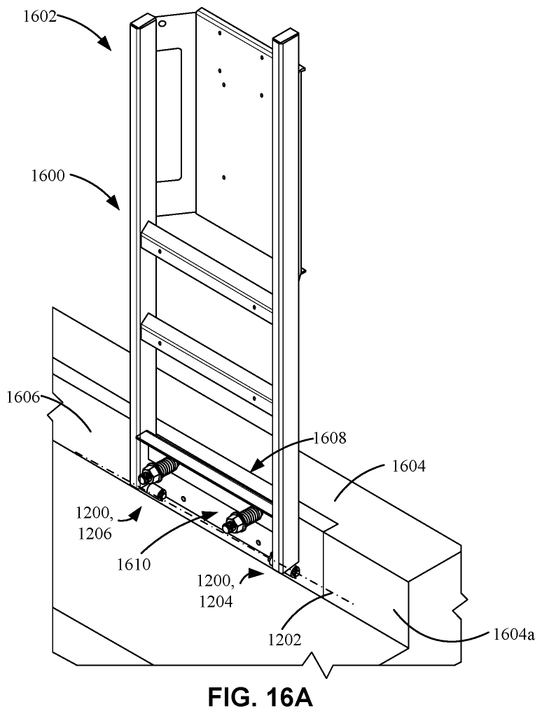

FIG. 15A is a perspective, rear view of the control panel 136 of FIG. 14A when in the deflected position 1400. FIG. 15B is a perspective, front view of the control panel 136 of FIG. 14A when in the deflected position 1400. When the control panel 136 is in the deflected position 1400, the first spring 1240 and the second spring 1240′ are in a second compressed state 1502. The second compressed state 1502 is greater than the first compressed state 1302 of FIG. 13. For instance, when the control panel 136 deflects to the deflected position 1400, the support plate 1234, being attached to the first post 1106 and the second post 1108 moves toward the fasteners 1244 and 1244′ of the respective first spring assembly 1230 and the second spring assembly 1232. In turn, the support plate 1234 causes the first spring 1240 and the second spring 1240′ to compress to the second compressed state 1502 (e.g., because the springs 1240, 1240′ are captured between the first side 1234a of the support plate 1234 and the respective second fastener 244 and the fourth fastener 244′). Additionally, the slots 1246 and 1248 of the support plate 1234 enable the support plate 1234 to slide relative to and/or along a longitudinal axis of the first screw 1238 and the second screw 1238′ (e.g., between the respective first ends 1238a, 1238a′ and the second ends 1238b, 1238b′). After the impact force 1402 is removed or dissipated, the first spring 1240 and the second spring 1240′ return to the first compressed state 1302. In turn, the first spring 1240 and the second spring 1240′ impart the force 1304 against the support plate 1234 to cause the support plate 1234 and, thus, the control panel 136 to pivot in the first rotational direction 1306 about the pivot axis 1202 to the non-deflected position 1300 of FIG. 13. In some examples, the control panel 136 is not coupled to the carriage 406. Instead, the control panel 136 can be attached directly to the platform 108 adjacent the carriage 406. For example, the control panel 136 disclosed herein can be attached to the front face 108a of the platform 108 via the pivot hinge 1200.

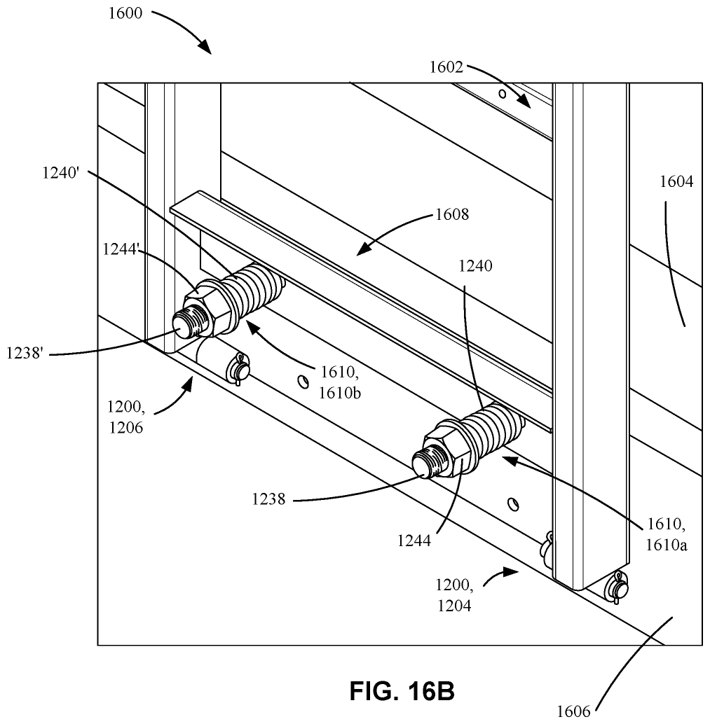

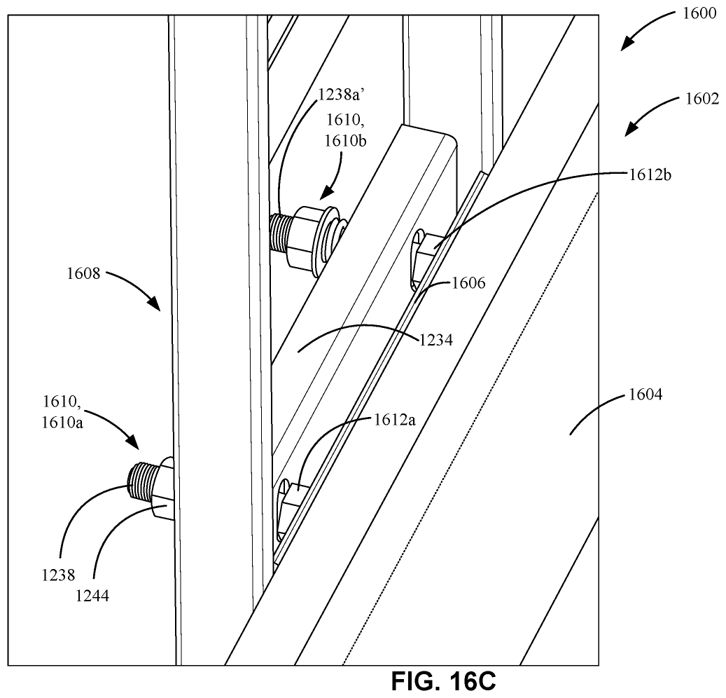

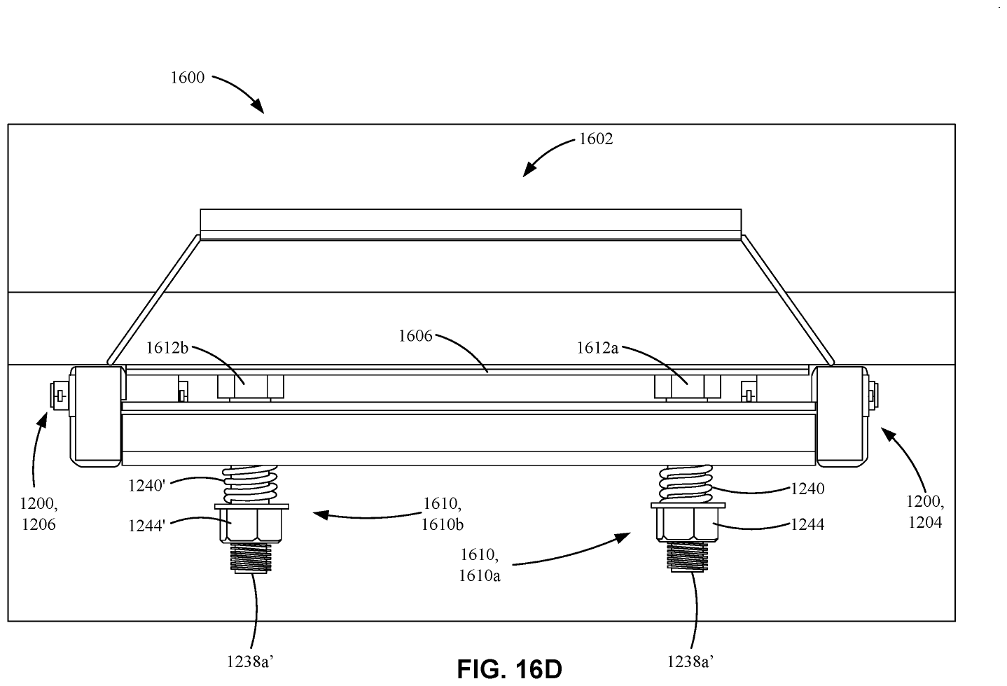

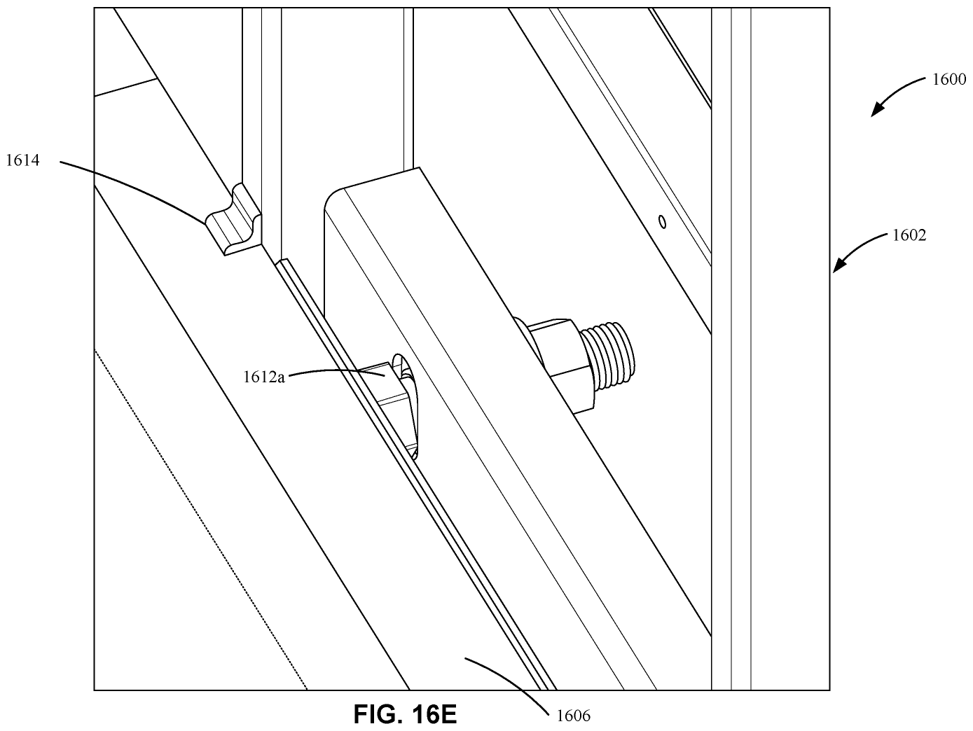

FIGS. 16A-16E are different views of another example loading dock 1600 including another example control panel 1602 disclosed herein. FIG. 16A is a perspective view of the loading dock 1600 and the control panel 1602. FIG. 16B is an enlarged, partial view of FIG. 16A. FIG. 16C is a perspective, rear view of the loading dock 1600 and the control panel 1602. FIG. 16D is a top view of the control panel 1602 and the loading dock 1600. FIG. 16E is a partial, perspective view of the control panel 1602. Many of the components of the example loading dock 1600 and/or control panel 1602 are substantially similar or identical to the components described above in connection with FIGS. 1-15B. As such, those components will not be described in detail again below. Instead, the interested reader is referred to the above corresponding descriptions for a complete written description of the structure and operation of such components. To facilitate this process, similar or identical reference numbers will be used for like structures in FIGS. 16A-16E as used in FIGS. 1-15B. For instance, the control panel 1602 includes a first post 1106, a second post 1108, and a pivot hinge 1200.

Referring to FIGS. 16A-16D, the control panel 1602 is coupled to (e.g., directly coupled or mounted to) a platform 1604 (i.e., instead of a carriage (e.g., the carriage 406)). The control panel 136 of the illustrated example is attached to the platform 1604 (e.g., a vertical wall 1604a) via a mounting plate 1606 (e.g., a fixed mounting plate). The mounting plate 1606 fixes a lateral position of the control panel 136. Thus, the control panel 1602 of FIG. 16A cannot move in the first direction 114 (e.g., a lateral direction of FIGS. 1-15). However, the control panel 1602 is pivotally coupled to the platform 1604 via a deflection system 1608.

The deflection system 1608 of the illustrated example includes a pivot hinge 1200 and a biasing assembly 1610. In particular, the control panel 1602 of the illustrated example is pivotally coupled to the platform 1604 via the pivot hinge 1200 and can pivot about the pivot axis 1202. The pivot hinge 1200 of the illustrated example is substantially similar to the pivot hinge 1200 of FIG. 12 except that the pivot hinge 1200 is coupled to the mounting plate 1606.

Additionally, the biasing assembly 1610 biases the control panel 1602 to the upright orientation. The biasing assembly 1610 is substantially similar to the biasing assembly 1210 of FIGS. 12A-12C except the mounting brackets 1236, 1236′ and the fasteners 1242, 1242′ are omitted. Instead, the biasing assembly 1610 of the illustrated example includes a first spring assembly 1610a and a second spring assembly 1610b. The first spring assembly 1610a has a first bolt or screw 1238, a first spring 1240, a fastener 1244 and a first mounting fastener 1612a. The second spring assembly 1610b has a second bolt or screw 1238′, a second spring 1240′, a second fastener 1244′ and a second mounting fastener 1612b. The mounting fasteners 1612a, 1612b (e.g., threaded nuts, etc.) are coupled or attached to the mounting plate 1606 and/or the vertical wall 1604a of the loading dock 1700 to receive respective ones of the screws 1238, 1238′. The fasteners 1612 are positioned between a support plate 1234 of the biasing assembly 1610 and the mounting plate 1606 and/or the vertical wall 1604a. In operation, the pivot hinge 1200 and the biasing assembly 1610 enables the control panel 1602 to pivot relative to the platform 1604 when impacted by a vehicle. In other words, the mounting plate 1606 does not impede operation of the deflection system 1608. Thus, the deflection system 1608 of the control panel 1602 of the illustrated example enables the control panel 1602 to pivot relative to the platform 1604 about the pivot axis 1202 defined by the pivot hinge 1200.

Referring to FIG. 16E, a stop or rubber fixture 1614 can be attached to the mounting plate between the control panel 1602 and the mounting plate 1606 to reduce impact when the control panel 1602 moves toward the non-deflected position 1300 or upright orientation.

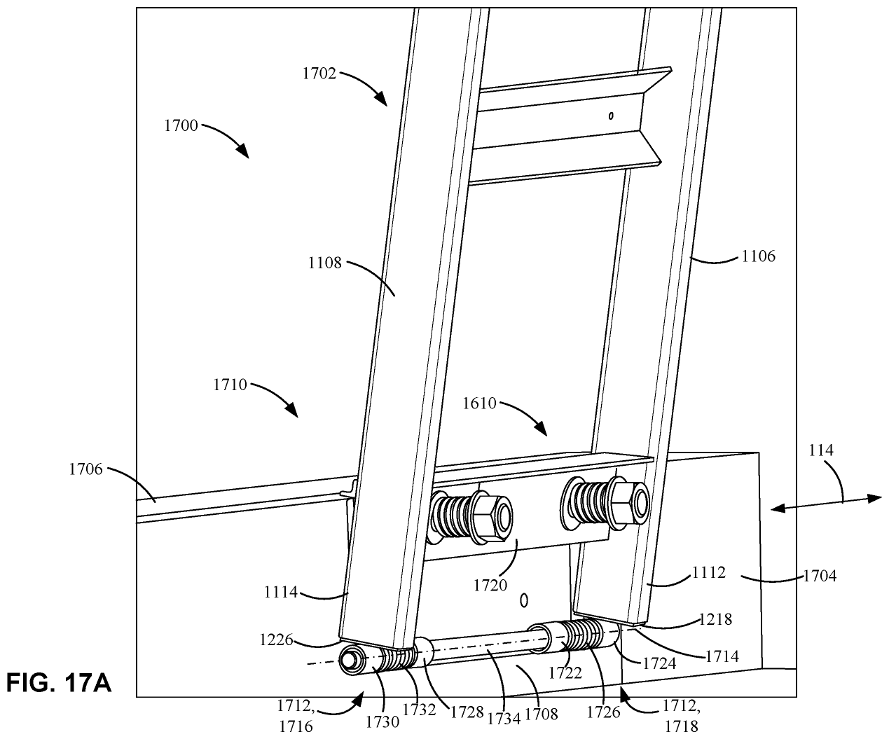

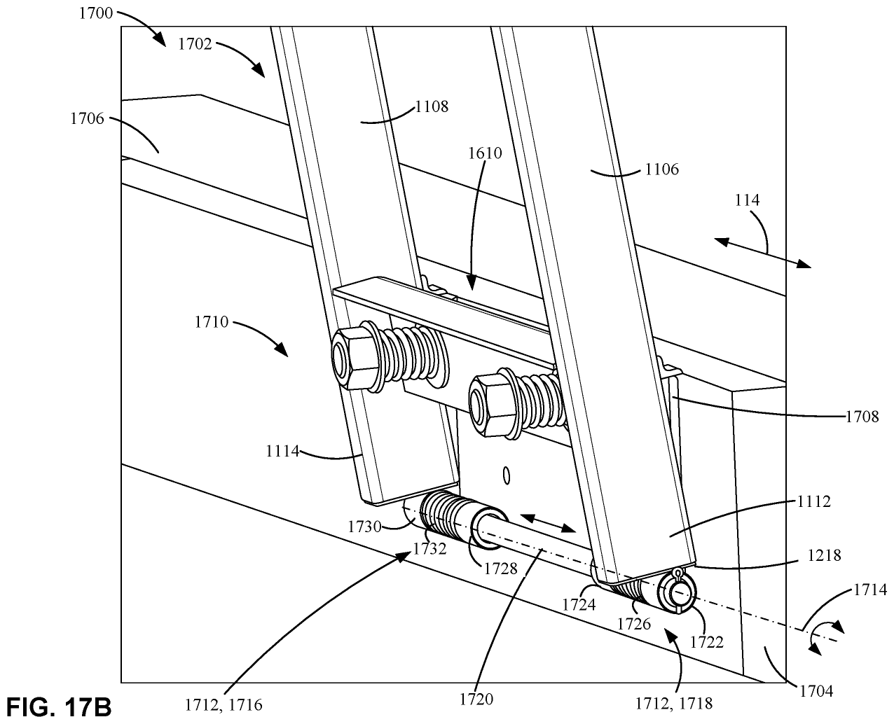

FIG. 17A is a perspective view of an example loading dock 1700 having another example control panel 1702 disclosed herein. FIG. 17B is another perspective view of the example loading dock 1700 of FIG. 17A. Many of the components of the example loading dock 1700 and/or control panel 1702 are substantially similar or identical to the components described above in connection with FIGS. 1-16E. As such, those components will not be described in detail again below. Instead, the interested reader is referred to the above corresponding descriptions for a complete written description of the structure and operation of such components. To facilitate this process, similar or identical reference numbers will be used for like structures in FIGS. 17A and 17B as used in FIGS. 1-16E. For instance, the control panel 1702 includes a first post 1106, a second post 1108 and a biasing assembly 1610 (e.g., a spring or biasing system of FIGS. 16A-16E).

Referring to FIGS. 17A and 17B, the control panel 1702 of the illustrated example is mounted to a face 1704 (e.g., a vertical wall) of a platform 1706 of the loading dock 1700. Specifically, the control panel 1702 is coupled to (e.g., directly coupled or mounted to) the face 1704 (e.g., a vertical wall) via a mounting plate 1708 (e.g., a fixed mounting plate). Specifically, the control panel 1702 is pivotally and slidably coupled relative to the face 1704 and/or the platform 1706. To pivotally and slidably couple the control panel 1702 relative to the platform 1706, the control panel 1702 of the illustrated example includes a deflection system 1710. The deflection system 1710 of the illustrated example includes a pivot hinge 1712 and a biasing assembly 1610.

The pivot hinge 1712 of the illustrated example enables the control panel 1702 to pivot relative to the face 1704 about a pivot axis 1202 and slidably or laterally move relative to the face 1704 in a first direction 114 along a pivot axis 1714 of the pivot hinge 1712. The first direction 114 of the illustrated example is substantially parallel relative to the face 1704 of the platform 1706. The biasing assembly 1210 biases the control panel 1702 to the upright orientation. The pivot hinge 1712 and the biasing assembly 1610 enable the control panel 1702 to pivot relative to the platform 1706 about the pivot axis 1714 and/or slide along the pivot axis 1714 in the first direction 114 when impacted by a vehicle. In other words, the mounting plate 1708 does not impede operation of the deflection system 1710.

The pivot hinge 1712 of the illustrated example includes a first pivot hinge 1716 and a second pivot hinge 1718. The first pivot hinge 1716 pivotally couples the first post 1106 and the mounting plate 1708 and the second pivot hinge 1718 pivotally couples the second post 1108 and the mounting plate 1708. Although the pivot hinge 1712 of the illustrated example includes the first pivot hinge 1716 and the second pivot hinge 1718, the first pivot hinge 1716 and the second pivot hinge 1718 enable the first post 1106 and the second post 1108 to move or pivot simultaneously relative to the mounting plate 1708 about the pivot axis 1714 because the first post 1106 is coupled to the second post 1108 via a panel (e.g., the panel 1110), a support plate 1720 and/or the biasing assembly 1210.

The first pivot hinge 1716 (e.g., a piano hinge) of the illustrated example includes a first knuckle 1722, a second knuckle 1724 and a first biasing element or spring 1726. The second pivot hinge 1718 (e.g., a piano hinge) of the illustrated example includes a third knuckle 1728, a fourth knuckle 1730 and a second biasing element or spring 1732. A pin or rod 1734 slidably couples the first pivot hinge 1716 and the second pivot hinge 1718.

The first knuckle 1722 of the first pivot hinge 1716 is coupled to the mounting plate 1708. Specifically, the first knuckle 1722 is attached to a front surface 1708a of the mounting plate 1708. The first knuckle 1722 is attached or fixed to the mounting plate 1708 via, for example, welding. The second knuckle 1724 is coupled to the first post 1106. In this example, the second knuckle 1724 is attached or fixed (e.g., welded) to an end surface 1218 of a first end 1112 of the first post 1106. The rod 1734 maintains alignment of the first knuckle 1722 and the second knuckle 1724 relative to the pivot axis 1202 to enable the first post 1106 to pivot relative to the platform 1706 about the pivot axis 1202.

The third knuckle 1728 of the second pivot hinge 1718 is coupled to the mounting plate 1708. Specifically, the third knuckle 1728 is attached to the front surface 1708a of the mounting plate 1708. The third knuckle 1728 is attached or fixed to the mounting plate 1708 via, for example, welding. The fourth knuckle 1730 is coupled to the second post 1108. In this example, the fourth knuckle 1730 is attached or fixed (e.g., welded) to an end surface 1226 of a first end 1114 of the second post 1108. The rod 1734 maintains alignment of the third knuckle 1728 and the fourth knuckle 1730 relative to the pivot axis 1202 to enable the second post 1108 to pivot relative to the platform 1706 about the pivot axis 1202.

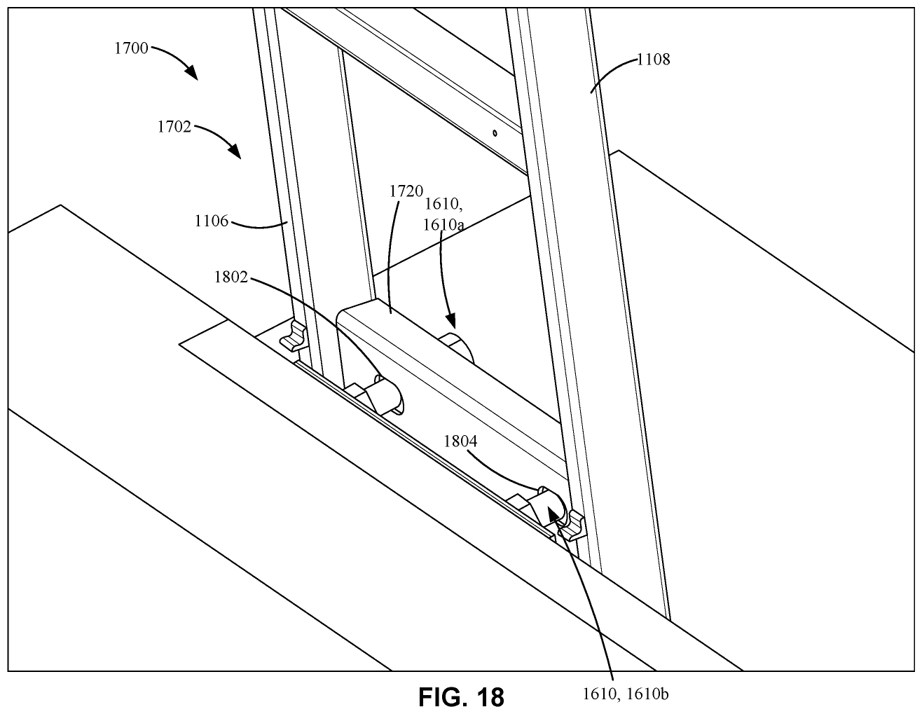

FIG. 18 is a rear view of the example control panel 1702 of FIGS. 17A and 17B. Referring to FIG. 18, the support plate 1720 of the illustrated example extends between the first post 1106 and the second post 1108. The support plate 1720 includes a first opening 1802 and a second opening 1804 to receive a first spring assembly 1610a and a second spring assembly 1610b of the biasing assembly 1610. Specifically, the first opening 1802 and the second opening 1804 are substantially similar to the slots 1248 and 1246 of FIGS. 12A and 12B except that the first opening 1802 and the second opening 1804 of the illustrated example have an oblong, oval or ellipsoidal shape. Specifically, a major axis of the first opening 1802 and the second opening 1804 is substantially horizontal or parallel relative to the pivot axis 1714 and a minor axis of the first opening 1802 and the second opening 1804 is substantially vertical or perpendicular relative to the pivot axis 1714. In other words, the first opening 1802 and the second opening 1804 have elongated shapes in a horizontal orientation or along the pivot axis 1714 to enable the control panel 1702 to slide side-to-side in the first direction 114 relative to the platform 1706. In some examples, the first opening 1802 and the second opening 1804 can be replaced by an elongated slot (e.g., a slot extending between or connecting the first opening 1802 and the second opening 1804).

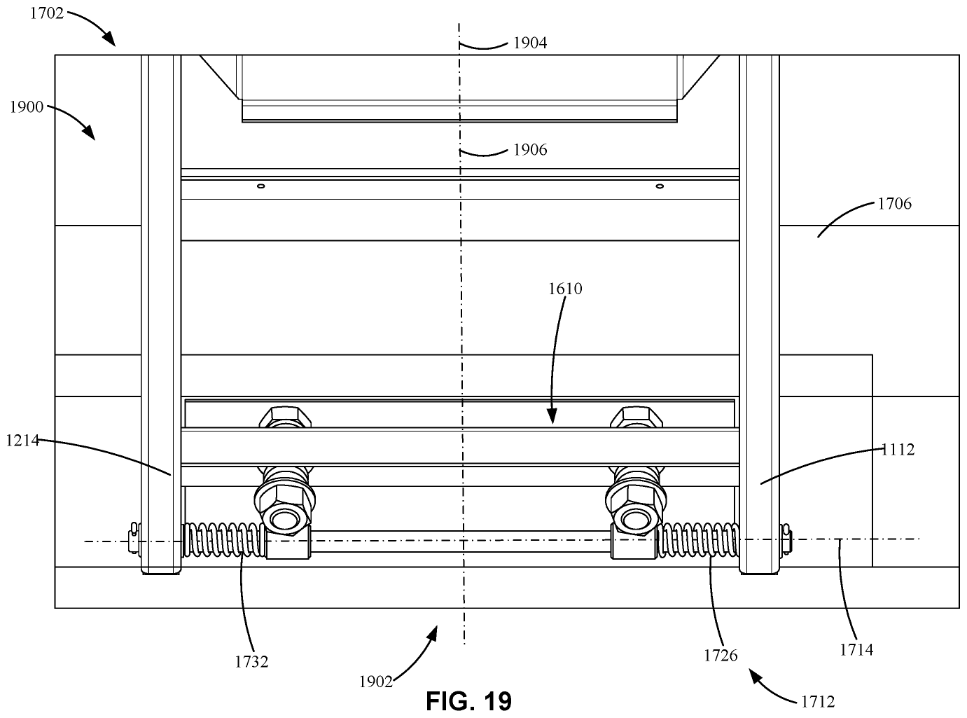

FIG. 19 is a partial front view of the control panel 1702 in a first example position 1900. In operation, the biasing assembly 1610 of the illustrated example maintains the control panel 1702 in a non-deflected or an upright orientation (e.g., the non-deflected position 1300 of FIG. 13). For example, the biasing assembly 1610 of the illustrated example biases the control panel 1702 about the pivot axis 1714 in a direction toward the platform 1706. In this manner, the first ends 1112, 1114 of the respective first post 1106 and the second post 1108 are biased into engagement (e.g., direct contact) with the platform 1706. In response to an impact event, the biasing assembly 1210 enables the control panel 1702 to pivot about the pivot axis 1714 in a direction away from the platform 1706. When the control panel 1702 is deflected or pivoted about the pivot axis 1714 in a direction away from the platform 1706, the biasing assembly 1210 causes the control panel 1702 to return to the upright orientation after a force from an impact event is removed from the control panel 1702.

Additionally, the first spring 1726 and the second spring 1732 (e.g., a lateral spring assembly) of the pivot hinge 1712 of the illustrated example maintains the control panel 1702 in a non-impact, lateral position 1902. For example, the first spring 1726 and the second spring 1732 of the pivot hinge 1712 centers the control panel 1702 relative to a vertical center reference line 1904. In other words, a center 1906 (e.g., a vertical center) of the control panel 1702 aligns with the vertical center reference line 1904 during a non-impact event.

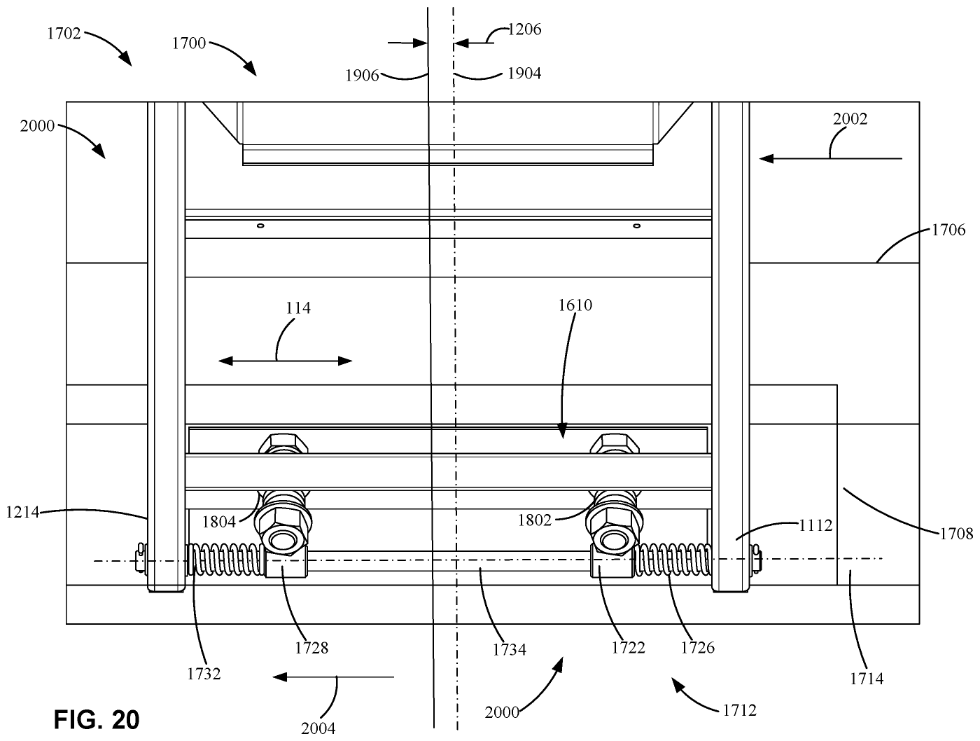

FIG. 20 is a partial front view of the control panel 1702 in a laterally deflected position 2000. During an impact event, the pivot hinge 1712 provides a slider to enable the control panel 1702 to slide in the first direction 114 relative to the platform 1706. For example, in response to a lateral force imparted to the control panel 1702 during an impact event, the control panel 1702 can slide along the rod 1734 laterally in the first direction 114 (e.g., a bidirectional direction). For example, in the illustrated example, a lateral force 2002 imparted to the first post 1106 causes the control panel 1702 to shift or slide along the pivot axis 1714 and/or the rod 1734 in a first lateral direction 2004. As a result, the second knuckle 1724 (FIG. 17A) slides along the rod 1734 to compress the first spring 1726 against the first knuckle 1722, which is fixed to the mounting plate 1708. Thus, the first knuckle 1722 does not slide relative to the platform 1706 and/or the mounting plate 1708 and the second knuckle 1724 can slide along the rod 1734 relative to the platform 1706 and/or the mounting plate 1708. Likewise, the fourth knuckle 1730 (FIG. 17B) moves in the first lateral direction 2004 away from the third knuckle 1728, which is fixed to the mounting plate 1708. Thus, the third knuckle 1728 does not slide relative to the platform 1706 and/or the mounting plate 1708 and the fourth knuckle 1730 can slide along the rod 1734 relative to the platform 1706 and/or the mounting plate 1708. Additionally, the first opening 1802 and the second opening 1804 of the support plate 1720 enables the control panel 1702 to shift in the first lateral direction 2004. The first knuckle 1722 and the third knuckle 1728 remain fixed to the mounting plate 1708. In other words, the center 1906 (e.g., a vertical center) of the control panel 1702 is offset relative to the vertical center reference line 1904 by a distance 2006 (e.g., a maximum lateral distance) during an impact event. In some examples, the distance 2006 can be limited by the openings 1802, 1804. In some examples, the support plate 1720 can include an elongated slot to increase an amount of the distance 2006. After the lateral force 2002 from the impact event is removed from the control panel 1702, the first spring 1726 and the second spring 1732 (e.g., a lateral spring assembly) of the pivot hinge 1712 of the illustrated example causes the control panel 1702 (e.g., the second knuckle 1724 and the fourth knuckle 1730) to return to the non-impact, lateral position 1902 of FIG. 19 (e.g., such that the center 1906 of the control panel 1702 aligns with the vertical center reference line 1904). The control panel 1702 is not limited to direct coupling to a platform. In some examples, the control panel 1702 can be coupled to the carriage 406 of FIG. 4.

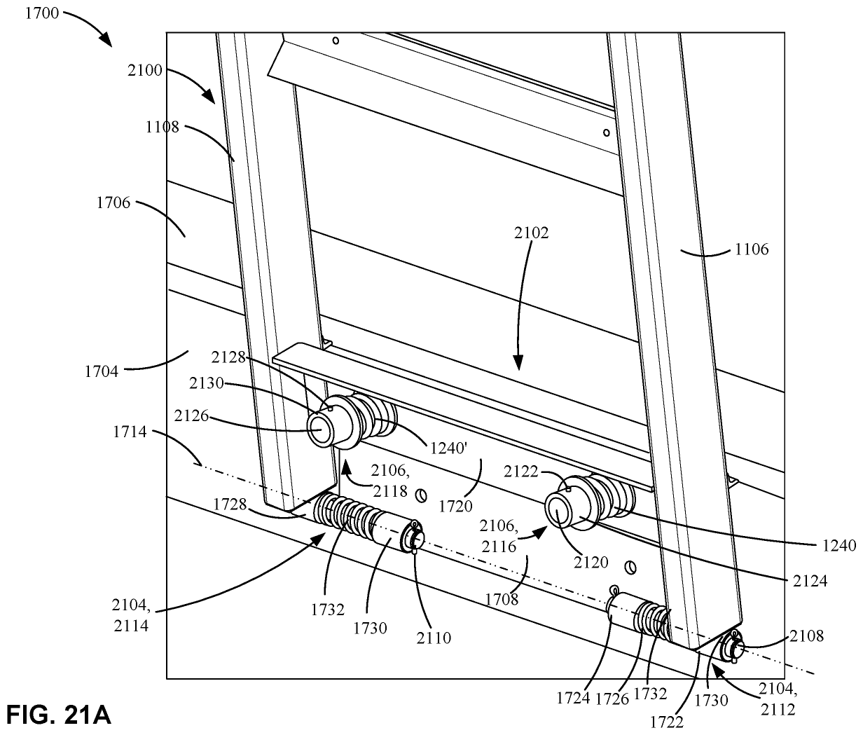

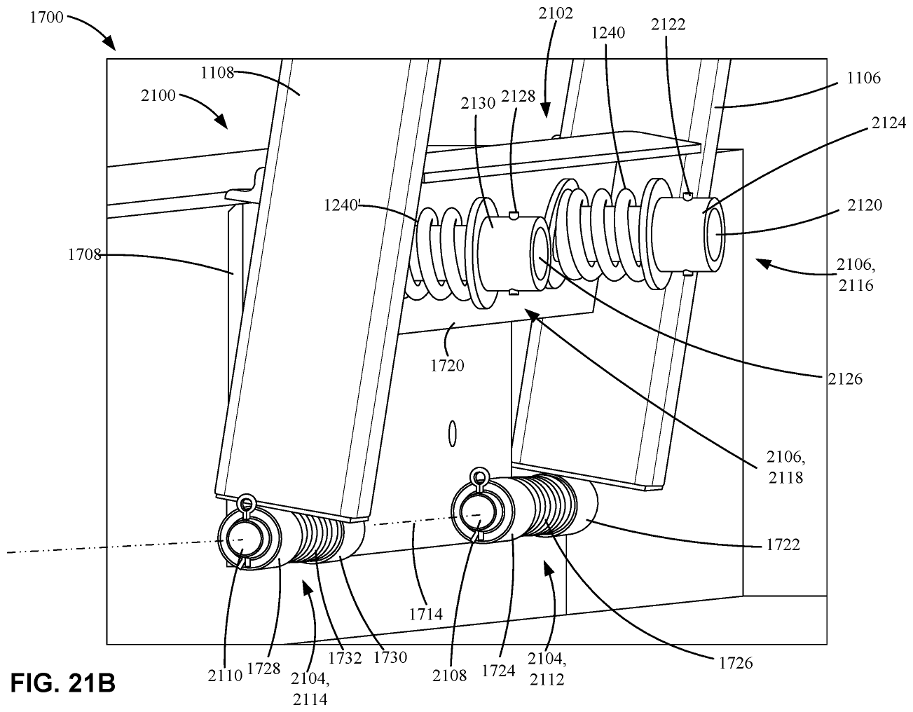

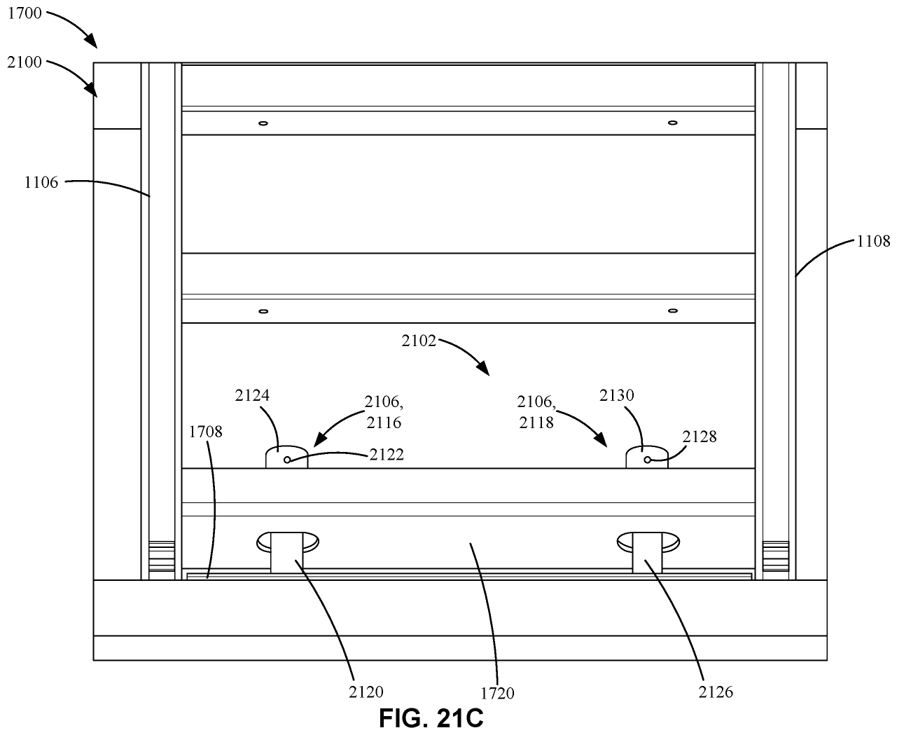

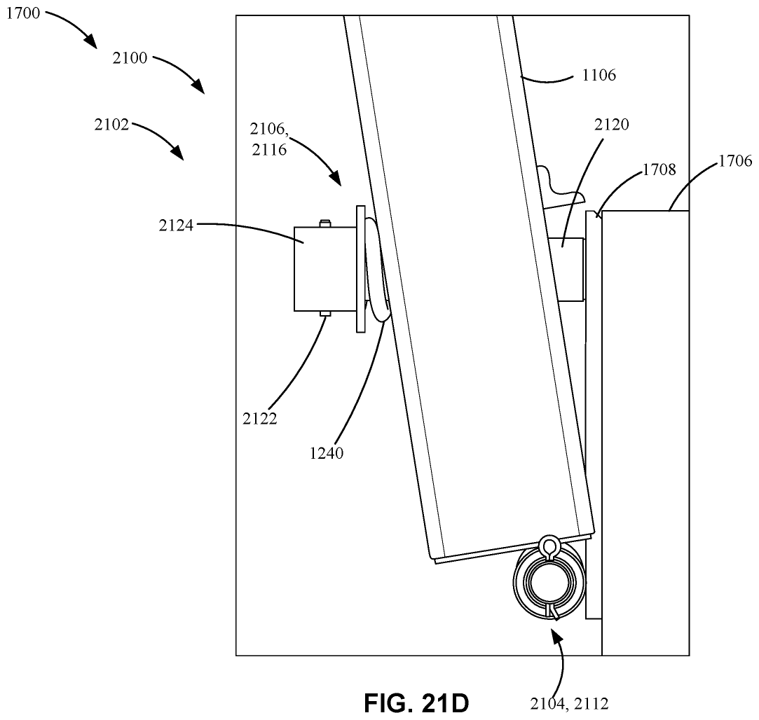

FIG. 21A is a perspective view of another example control panel 2100 disclosed herein. FIG. 21B is another perspective view of the example control panel 2100 of FIG. 21A. FIG. 21C is a perspective, rear view of the example control panel 2100 of FIGS. 21A and 21B. FIG. 21D is a side view of the example control panel 2100 of FIGS. 21A and 21B. Many of the components of the example control panel 2100 are substantially similar or identical to the components described above in connection with FIGS. 1-20. As such, those components will not be described in detail again below. Instead, the interested reader is referred to the above corresponding descriptions for a complete written description of the structure and operation of such components. To facilitate this process, similar or identical reference numbers will be used for like structures in FIGS. 21A-21D as used in FIGS. 1-20. For instance, the control panel 2100 includes a first post 1106, a second post 1108, and a support plate 1720.

Referring to FIGS. 21A-21D, the control panel 2100 of the illustrated example is mounted to a face 1704 (e.g., a vertical wall) of a platform 1706 of a loading dock 1700. The control panel 2100 is coupled to (e.g., directly coupled or mounted to) the face 1704 (e.g., a vertical wall) via a mounting plate 1708 (e.g., a fixed mounting plate). Specifically, the control panel 2100 is pivotally and slidably coupled relative to the face 1704 and/or the platform 1706. To pivotally and slidably couple the control panel 2100 relative to the platform 1706, the control panel 2100 of the illustrated example includes a deflection system 2102. The deflection system 2102 of the illustrated example includes a pivot hinge 2104 and a biasing assembly 2106.

The pivot hinge 2104 is substantially similar to the pivot hinge 1712 of FIGS. 17A and 17B except the rod 1734 is omitted and replaced by a first pivot pin or rod 2108 and a second pivot pin or rod 2110. For example, the pivot hinge 2104 of the illustrated example includes a first pivot hinge 2112 and a second pivot hinge 2114. The first pivot hinge 2112 (e.g., a piano hinge) of the illustrated example includes a first knuckle 1722, a second knuckle 1724, a first biasing element or spring 1726, and the first pin 2108. The first pin 2108 pivotally and slidably couples the first pivot hinge 2112 relative to the platform 1706 and/or the loading dock 1700 and maintains alignment of the first knuckle 1722 and the second knuckle 1724 relative to a pivot axis 1714. The second pivot hinge 2114 (e.g., a piano hinge) of the illustrated example includes a third knuckle 1728, a fourth knuckle 1730, a second biasing element or spring 1732, and the second pin 2110. The second pin 2110 pivotally and slidably couples the second pivot hinge 2114 relative to the platform 1706 and/or the loading dock 1700 and maintains alignment of the third knuckle 1728 and the fourth knuckle 1730 relative to the pivot axis 1714.

The biasing assembly 2106 of the illustrated example interacts with a support plate 1720 of the control panel 2100. The biasing assembly 2106 of the illustrated example is substantially similar to the biasing assembly 1610 of FIGS. 17A and 17B except the screws 1238, 1238′ and the fasteners 1612a, 1612b are omitted. The biasing assembly 2106 of the illustrated example includes a first spring assembly 2116 and a second spring assembly 2118. The first spring assembly 2118 has a first rod 2120, a first shear pin 2122, a first spring 1240, a first retainer 2124. The first shear pin 2122 extends through an opening in the first retainer 2124 and the first rod 2120 to couple the first retainer 2124 and the first rod 2120. The first retainer 2124 retains the first spring 1240 coupled to the first rod 2120 between the first retainer 2124 and the support plate 1720. Additionally, the first rod 2120 of the illustrated example is a non-threaded fastener and is welded to the mounting plate 1708.

The second spring assembly 2120 has a second rod 2126, a second shear pin 2128, a second spring 1240′ and a second retainer 2130. The second retainer 2130 retains the second spring 1240′ coupled to the second rod 2126 between the second retainer 2130 and the support plate 1720. The second shear pin 2128 extends through an opening in the second retainer 2130 and the second rod 2126 to couple the second retainer 2130 and the second rod 2126. The second rod 2126 of the illustrated example is a non-threaded fastener and is welded to the mounting plate 1708. In operation, the shear pins 2122, 2128 can shear or break when an amount of force applied to the control panel 2100 exceeds a threshold force. In this manner, damage to the platform 1706 (the vertical wall 1706a) can be prevented or reduced.

The example loading bay 100, the ramp mover 134, the control panel 136, the loading dock 1600, the control panel 1602, the loading dock 1700, the control panel 1702 and/or the control panel 2100 is not limited to railcar ramp systems, warehouses, etc. For example, the control panels 136, 1602, 1702, 2100 disclosed herein can be coupled a loading dock to receive a vehicle, a warehouse, an interior of a building, an exterior of a building, and/or any other structure. In some examples, the control panel 136, the control panel 1602, the control panel 1702, and/or the control panel 2100 disclosed herein can be coupled to a loading dock and/or any other structure of a loading dock located outside of the loading dock or warehouse or inside of a loading dock or warehouse. For example, the control panel 136 the control panel 1602, the control panel 1702, and/or the control panel 2100 can be attached inside a warehouse where material handling equipment can impact or accidentally hit the control panel.

The foregoing examples of railcar ramp system 102, the control panel 136, the control panel 1602, the control panel 1702, the control panel 2100 and/or other components disclosed herein can be employed with railcar loading system, a loading dock, a warehouse, and/or any other transport or storage system. Although each example of the railcar ramp system 102, the control panel 136, the control panel 1602, the control panel 1702, and/or the control panel 2100 disclosed above have certain features and/or components, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features. In some examples, a dock leveler, a railcar loading bay, a warehouse, an interior of a warehouse, an exterior of a warehouse, etc. in accordance with the teachings of this disclosure may have a combination of the features of the example disclosed herein. For example, in some examples, the pivot hinge 1712 of FIG. 17A can be implemented with the carriage 406 of FIG. 4.

At least some of the aforementioned examples include one or more features and/or benefits including, but not limited to, the following:

Example 1 includes a railcar ramp system including a carriage slidably coupled to a platform via a track guide; and a ramp mover assembly pivotally coupled to the carriage, the ramp mover assembly positionable between a stored position and an active position, in the active position, the ramp mover assembly to enable movement of the carriage in a lateral direction along the track guide.

Example 2 includes the railcar ramp system of example 1, where the carriage is to slide horizontally relative to the platform.

Example 3 includes the railcar ramp system of any one of examples 1-2, further including a leveler coupled to the carriage.

Example 4 includes the railcar ramp system of any one of examples 1-3, the ramp mover assembly includes a first frame attached to the carriage and a second frame pivotally coupled to the first frame via a hinge, the hinge to enable the second frame to pivot relative to the first frame or the carriage.

Example 5 includes the railcar ramp system of any one of examples 1-4, where the hinge includes a first barrel fixed to the first frame, a second barrel fixed to the second frame, and a pin to couple the first barrel and the second barrel.

Example 6 includes the railcar ramp system of any one of examples 1-5, where the pin defining a pivot axis of the hinge.

Example 7 includes a railcar ramp system having a carriage slidably coupled to a platform via a track guide; and a control panel pivotally coupled to the carriage, the control panel positionable between a non-deflected position and a deflected position, in the deflected position, the control panel to pivot away from the platform in a rotational direction.

Example 8 includes the railcar ramp system of example 7, where the control panel is to rotate about a hinge axis relative to the platform.

Example 9 includes the railcar ramp system of any one of examples 6-8, where the control panel includes a first post, a second post and a panel coupling the first post and the second post.

Example 10 includes the railcar ramp system of any one of examples 6-9, where a first end of the first post is pivotally coupled to the carriage via a first hinge and a second end of the second post is pivotally coupled to the carriage via a second hinge.

Example 11 includes the railcar ramp system of any one of examples 6-10, where the first hinge includes a first knuckle coupled to the first end of the first post, a second knuckle coupled to the carriage, and a first pin to pivotally couple the first knuckle and the second knuckle, the first pin defining a pivot axis of the first hinge.

Example 12 includes the railcar ramp system of any one of examples 6-11, where the second hinge includes a third knuckle coupled to the first end of the second post, a fourth knuckle coupled to the carriage, and a second pin to pivotally couple the third knuckle and the fourth knuckle, the second pin defining a pivot axis of the second hinge.

Example 13 includes the railcar ramp system of any one of examples 6-12, further including a biasing system to bias the control panel to an upright orientation.

Example 14 includes the railcar ramp system of any one of examples 6-13, where the biasing system includes a first spring assembly and a second spring assembly, the first and second spring assemblies including springs to bias the control panel toward the upright orientation.

Example 15 includes the railcar ramp system of any one of examples 6-14, where the biasing system to enable the control panel to deflect away from the platform when an impact force is applied to the control panel.

Example 16 includes a control panel assembly including a control panel, a mounting plate to couple the control panel to a platform, and a deflection system including a pivot hinge to pivotally couple the control panel and the platform.

Example 17 includes the control panel assembly of example 16, where the deflection system includes a biasing assembly to bias the control panel to an upright position.

Example 18 includes the control panel assembly of any one of examples 16-17, where the biasing assembly includes a first spring assembly and a second spring assembly.

Example 19 includes the control panel assembly of any one of examples 16-18, where the first spring assembly includes a first screw, a first spring, a first nut, and a first mounting fastener, the first mounting fasteners to attach to the mounting plate and receive a first end of the first screw, the first screw to receive the first spring, and the first nut to couple to a second end of the first spring to retain the first spring coupled to the first screw, wherein a support plate of the control panel is positioned between the first nut and the first mounting fastener.

Example 20 includes the control panel assembly of any one of examples 16-19, where the deflection system further enables slidable movement of the control panel in a first lateral direction and a second lateral direction relative to the platform, and wherein the pivot hinge includes a first knuckle and a second knuckle coupled via a pin, the first knuckle coupled to the mounting plate and the second knuckle coupled to a frame of the control panel, the pivot hinge to enable pivotal movement of the control panel relative to the mounting plate and slidable movement of the control panel relative to the platform.

The following claims are hereby incorporated into this Detailed Description by this reference. Although certain examples, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A railcar ramp system comprising:
a carriage slidably coupled to a platform via a track guide; and
a ramp mover assembly pivotally coupled to the carriage, the ramp mover assembly positionable between a stored position and an active position, in the active position, the ramp mover assembly to enable movement of the carriage in a lateral direction along the track guide.

2. The railcar ramp system of claim 1, wherein the carriage is to slide horizontally relative to the platform.

3. The railcar ramp system of claim 1, further including a leveler coupled to the carriage.

4. The railcar ramp system of claim 1, wherein the ramp mover assembly includes a first frame attached to the carriage and a second frame pivotally coupled to the first frame via a hinge, the hinge to enable the second frame to pivot relative to the first frame or the carriage.

5. The railcar ramp system of claim 4, wherein the hinge includes a first barrel fixed to the first frame, a second barrel fixed to the second frame, and a pin to couple the first barrel and the second barrel.

6. The railcar ramp system of claim 5, wherein the pin defines a pivot axis of the hinge.

7. A railcar ramp system comprising:
a carriage slidably coupled to a platform via a track guide; and
a control panel pivotally coupled to the carriage, the control panel positionable between a non-deflected position and a deflected position, in the deflected position, the control panel to pivot away from the platform in a rotational direction.

8. The railcar ramp system of claim 7, wherein the control panel is rotatable about a hinge axis relative to the platform.

9. The railcar ramp system of claim 7, wherein the control panel includes a first post, a second post and a panel coupling the first post and the second post.

10. The railcar ramp system of claim 9, wherein a first end of the first post is pivotally coupled to the carriage via a first hinge and a second end of the second post is pivotally coupled to the carriage via a second hinge.

11. The railcar ramp system of claim 10, wherein the first hinge includes a first knuckle coupled to the first end of the first post, a second knuckle coupled to the carriage, and a first pin to pivotally couple the first knuckle and the second knuckle, the first pin defining a pivot axis of the first hinge.

12. The railcar ramp system of claim 11, wherein the second hinge includes a third knuckle coupled to the first end of the second post, a fourth knuckle coupled to the carriage, and a second pin to pivotally couple the third knuckle and the fourth knuckle, the second pin defining a pivot axis of the second hinge.

13. The railcar ramp system of claim 7, further including a biasing system to bias the control panel to an upright orientation.

14. The railcar ramp system of claim 13, wherein the biasing system includes a first spring assembly and a second spring assembly, the first and second spring assemblies including springs to bias the control panel toward the upright orientation.

15. The railcar ramp system of claim 14, wherein the biasing system to enable the control panel to deflect away from the platform when an impact force is applied to the control panel.

16. A control panel comprising:
a control panel;
a mounting plate to couple the control panel to a platform; and
a deflection system including a pivot hinge to pivotally couple the control panel and the platform.

17. The control panel of claim 16, wherein the deflection system includes a biasing assembly to bias the control panel to an upright position.

18. The control panel of claim 17, wherein the biasing assembly includes a first spring assembly and a second spring assembly.

19. The control panel of claim 18, wherein the first spring assembly includes a first screw, a first spring, a first nut, and a first mounting fastener, the first mounting fasteners to attach to the mounting plate and receive a first end of the first screw, the first screw to receive the first spring, and the first nut to couple to a second end of the first spring to retain the first spring coupled to the first screw, wherein a support plate of the control panel is positioned between the first nut and the first mounting fastener.

20. The control panel of claim 16, wherein the deflection system further enables slidable movement of the control panel in a first lateral direction and a second lateral direction relative to the platform, and wherein the pivot hinge includes a first knuckle and a second knuckle coupled via a pin, the first knuckle coupled to the mounting plate and the second knuckle coupled to a frame of the control panel, the pivot hinge to enable pivotal movement of the control panel relative to the mounting plate and slidable movement of the control panel relative to the platform.
